(19) United States
(12) Patent Application Publication
(10) Pub. No.: US 2026/0247457 A1
(43) Pub. Date: Aug. 20, 2026

(54) P2P COMMUNICATION METHOD AND SYSTEM WITH MULTI-LINK TDLS DIRECT LINK

(71) Applicant: CANON KABUSHIKI KAISHA, Tokyo (JP)

(72) Inventors: Pascal VIGER, JANZE (FR); Romain GUIGNARD, RENNES (FR)

(21) Appl. No.: 19/099,244

(22) PCT Filed: Jul. 25, 2023
(86) PCT No.: PCT/EP2023/070496

§ 371 Date: Jan. 28, 2025

(30) Foreign Application Priority Data
Jul. 29, 2022 (GB) 2211148.8

(51) Int. Cl. H04W 76/12; H04W 76/14; H04W 76/15

(52) U.S. Cl. CPC H04W 76/12; H04W 76/14; H04W 76/15

(57) ABSTRACT

Single link TDLS direct link according to IEEE 802.11be/D2.0 does not benefit from the multiple link features to improve aggregation, common block acknowledgement and retransmission through plural links. The invention provides multi-link TDLS direct link by augmenting TDLS Action frames exchanged during TDLS direct link establishment. The augmented frames signal plural TDLS links from amongst multiple setup communication links of the emitting non-AP MLD. Those links are intended links on which to establish the TDLS direct link. The other peer non-AP MLD can, through the frame exchange, negotiate another set of links. In embodiments, an augmented TDLS Multi-Link IE embeds Per-TDLS STA Profiles, each of which signals a specific TDLS link. A Profile conveys a Link ID and a MAC address of the corresponding affiliated STA of the transmitting non-AP MLD. The non-AP MLDs therefore share their affiliated STAs' MAC addresses, hence simplifying the signaling in the P2P data frames.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between STAs.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D2.0 version (May 2022, below “D2.0 standard”) introduces the Multi-Link (ML) Operation (MLO). MLO improves data throughput by allowing communications between STAs over multiple concurrent and non-contiguous communication links.

MLO enables a non-AP (Access Point) MLD (ML Device) to register with an AP MLD, i.e. to discover, authenticate, associate and set up multiple communication links with the AP MLD. Each communication link so setup (below “setup link”) enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

The existing Tunneled Direct Link Setup (TDLS) has been adapted to coexist with the MLDs of the D2.0 standard.

Formerly endorsed by IEEE 802.11z standard in 2008, TDLS enables devices (called TDLS peer STAs) to link directly to one another when connected to a traditional AP. To set up and maintain a direct link, both TDLS peer STAs shall be associated with the same infrastructure BSS (in short the same AP). The TDLS mechanism provides encapsulation of the setup frames exchanged between the two TDLS peer STAs, in Data frames. This allows the setup frames to be transmitted transparently (or “tunneled”) through the AP. The setup frames includes so-called TDLS Action frames. Once the direct link is setup, the TDLS peer STAs can communicate directly with one another, without involving the AP while remaining associated with the AP.

The D2.0 standard adapts the TDLS mechanism to the multi-link feature, by adjusting the signalling of MAC addresses in the setup frames when establishing a TDLS session over one of the multiple setup links. As a result, a direct link, made of a single communication link (e.g. a 20 MHz channel on either of the 2.4, 5 and 6 GHz bands), is established in between two wireless STAs (TDLS peer STAs), each affiliated with an MLD.

However, the D2.0-adapted TDLS mechanism does not take advantage of all benefits of the multi-link aggregation. As an example, while MLO allows a single block-acknowledgment session to be conducted on any setup link on behalf of the multiple setup links and allows a retransmission of a failed frame to be conducted on any setup link, the D2.0-adapted TDLS mechanism still requires the block-acknowledgment and the packet retransmission to be conducted on one and the same TDLS link.

There is thus a need to improve the TDLS mechanism in the context of the multi-link mechanism.

### SUMMARY OF INVENTION

It is a broad objective of the present invention to overcome some of the foregoing concerns.

The inventors have noticed that the above deficiencies come from the inability for the non-AP MLDs, to setup a TDLS session over multiple setup links. The present invention hence defines new mechanisms that allow such multi-link TDLS session to be setup.

In this context, embodiments of the invention are directed to a communication method in a wireless network, comprising at a (initiator or responder peer) non-access point, AP, multi-link device, MLD, having multiple setup communication links with an AP MLD:
establishing a Tunneled Direct Link Setup, TDLS, direct link with another non-AP station or MLD, by exchanging TDLS Action frames,
wherein one of the TDLS Action frames signals two or more of the multiple setup communication links, on which to establish the TDLS direct link.

The non-AP MLD may receive or transmit the signaling TDLS Action frame, depending on the current stage within the Tunneled Direct Link Setup.

The signaled two or more communication links are proposed (candidates) or used to form the multi-links of the established TDLS direct link. As a result, a multi-link TDLS direct link may be established, meaning direct transmission between the two non-AP entities can be performed using those “multi-links”.

Conventional TDLS Action frames are thus enhanced with one or more additional information elements, IEs, to allow the two non-AP entities to agree on multiple links for their TDLS session/direct link.

The resulting multi-link TDLS direct link advantageously allows aggregation amongst the multiple links, hence makes it possible to perform a single block-acknowledgment session for the multiple links of the TDLS direct link, as well as to perform retransmission over any of these multiple links.

Optional features of the invention are defined below with reference to a method, while they can be transposed into device features.

In some embodiments, the signaling TDLS Action frame includes a Link Identifier information element, IE, to signal a first one of the multiple setup communication links, and one or more additional IEs to signal a second one or more of the multiple setup communication links. The Link Identifier is defined in the D2.0 standard with a BSSID field set to the BSSID of an AP affiliated with the AP MLD. Hence, this signals the communication link set up with that affiliated AP. Also the TLDS initiator and responder STA Address fields may be set to the MLD MAC addresses of the two non-AP MLDs.

This configuration ensures backwards compatibility with legacy 802.11 stations, meaning at least a single link TDLS direct link can be established with a legacy 802.11 station based on that IE.

The first setup communication link may advantageously correspond to the link over which the signaling TDLS Action frame is transmitted. However, it is not mandatory and any other link intended for the multi-link TDLS direct link may be signaled as the first link.

In various embodiments, the signaling TDLS Action frame includes a plurality of Link Identifier IEs, each signaling one of the multiple setup communication links. Each Link Identifier IE may be set as above, with respective BSSID identifying respective affiliated APs of the AP MLD.

In various embodiments, the signaling TDLS Action frame further includes a Multi-Link Link IE signaling the second one or more of the multiple setup communication links. The Multi-Link Link IE is defined in the D2.0 standard. It includes a Link ID Bitmap, the bits of which can be set to indicate the second one or more of the multiple setup communication links. The bitmap may signal or not the first setup communication link.

This configuration advantageously limits overhead while recycling an existing IE to a new usage.

In various embodiments, the signaling TDLS Action frame further includes a Multi-Link IE having a Type field set to TDLS, signaling the second one or more of the multiple setup communication links. A Multi-Link IE with Type=3, i.e. TDLS, is defined in the D2.0 standard. This configuration again takes advantage of an existing IE.

In specific embodiments, a Link Info field of the TDLS Multi-Link IE includes one or more Per-TDLS STA Profiles, each of which signaling one of the multiple setup communication links. Each profile advantageously allows characteristics of each link to be provided to the other non-AP station or MLD. A Per-TDLS STA Profile may be based on the Per-STA Profile defined in the D2.0 Standard, section 9.4.2.312.2.3, e.g. having the same fields.

In some implementations, each of the Per-TDLS STA Profiles includes a Link ID field set to a link identifier of an AP that is affiliated with the AP MLD. This is the affiliated AP corresponding to the setup communication link signaled. The Link ID is representative of the tuple consisting of the Operating Class, the Operating Channel and the BSSID of the affiliated AP considered.

In some other implementations, each of the Per-TDLS STA Profiles includes a STA MAC Address field set to a MAC address of a STA, that is affiliated with the non-AP MLD sending the signaling TDLS Action frame. This allows the MAC addresses of the relevant affiliated STAs to be shared with the other non-AP station or MLD. Indeed, those MAC addresses may then be used for the direct communication through the multi-link TDLS direct link. In particular, that STA is the affiliated STA associated with the AP identified in the Link ID field of the same Per-TDLS STA Profile (i.e. corresponding to the link identified by the Link ID field).

In this context, the method may further comprise at the non-AP MLD receiving the signaling TDLS Action frame, responsive to the signaling TDLS Action frame, sending a response TDLS Action frame with a receiving address, RA, or destination address, DA, set to the MAC address of the STA. The RA is set in case the response is directly transmitted to the non-AP MLD sending the signaling TDLS Action frame, while the DA is set in case the response transits through the AP MLD. This configuration contrasts with the requirements of the D2.0 standard according to which the addresses in the MAC header must be MLD MAC addresses and not STA MAC addresses. The proposed configuration is made possible thanks to the signaling of the MAC addresses within the signaling TDLS Action frame, which signaling is not contemplated in the conventional TDLS Action frames according to the D2.0 standard.

Of course, the other addresses (TA, SA) if any in the MAC header can also be set with STA MAC addresses.

In some other implementations, the TDLS Multi-Link IE includes a subfield set to a value triggering two or more responses to the signaling TDLS Action frame over respectively the signaled second one or more setup communication links. The subfield may be embedded in each Per-TDLS STA Profile or provided within a Common Info field of the TDLS Multi-Link IE. The responses are sent by the recipient of the signaling TDLS Action frame. This configuration allows the sending non-AP MLD to get knowledge of which of the signaled setup communication links the other non-AP station or MLD operates on.

In this context, the method may further comprise at the non-AP MLD receiving the signaling TDLS Action frame, responsive to the signaling TDLS Action frame, sending a response TDLS Action frame over each of the signaled second one or more setup communication links on which the receiving non-AP MLD operates.

According to other specific features, the signaling TDLS Action frame may be a TDLS Action Request frame while the responses are TDLS Action Response frames. TDLS Action frames of request type and response type are defined in 802.11z. For example, TDLS Discovery Request/Response frames or TDLS Setup Request/Response frames are used here.

In some other implementations, one of the Per-TDLS STA Profiles signals the first setup communication link. This means this specific first link is signaled twice in the TDLS Action frame. This configuration advantageously allows some characteristics specific to the first link to be provided to the non-AP MLD receiving the frame. As an example already introduced above, this allows the MAC address of the affiliated STA operating on the first link to be known by the non-AP MLD receiving the frame.

In some other implementations, at least one (possibly each) of the Per-TDLS STA Profiles includes a STA Profile providing the IEs as defined in IEEE P802.11be/D2.0 for a TDLS Action frame of the same type (e.g. Discovery/Setup Request/Response) as the signaling TDLS Action frame. This aims at providing details on each communication link intended for the multi-link TDLS direct link, to the receiving non-AP MLD. Those IEs define for example capabilities or operational parameters related to the corresponding link.

In possible implementations, the signaling TDLS Action frame includes IEs describing the first setup communication link outside the TDLS Multi-Link IE, and a Per-TDLS STA Profile in the TDLS Multi-Link IE inherits from the IEs describing the first setup communication link and includes only IEs that differ from the IEs describing the first setup communication link. This inheritance scheme seeks to reduce the size of the TDLS Multi-Link IE conveying all the Per-TDLS STA Profiles.

According to specific features, an IE corresponding to a link-specific mechanism (hence specific to the first setup communication link) is not inherited from the IEs describing the first setup communication link. An exemplary link-specific mechanism regards the TWT or rTWT mechanism; hence TWT-related IEs are not inherited. Another exemplary link-specific mechanism regards the identification of the link; hence the Link Identifier IE is not inherited.

In possible implementations, a Common Info field of the TDLS Multi-Link IE includes a Link ID Info field comprising a link identifier of an AP that is affiliated with the AP MLD and that corresponds to the first setup communication link signaled in the Link Identifier IE. This configuration eases the retrieval of, e.g., the Per-TDLS STA Profile corresponding to the first setup communication link, in order to obtain detailed capabilities or operational parameters related to that link.

In a variant, the Link ID Info field may rather comprise a link identifier corresponding to the link over which the signaling TDLS Action frame is transmitted.

In some implementations, the signaling TDLS Action frame includes a Multi-Link Link IE preceding the TDLS Multi-Link IE within the signaling TDLS Action frame, wherein the Multi-Link Link IE comprises a Link ID Bitmap, the bits of which being set to indicate the second one or more of the multiple setup communication links.

This configuration allows a receiving station or MLD to have quick knowledge of the setup communication links described in the TDLS Multi-Link IE, hence eases a parsing of the latter to search for the descriptions of appropriate links.

In some embodiments, the method further comprises at the non-AP MLD, once the TDLS direct link is established on a plurality of setup communication links, exchanging a TDLS Teardown or Setup Request frame with the other non-AP station or MLD, wherein the TDLS Teardown or Setup Request frame signals an updated plurality of setup communication links on which updating the TDLS direct link.

This configuration allows the stations/MLDs to dynamically adjust the set of TDLS links over time, as the network or station conditions may evolve.

As an example, the TDLS Teardown frame may include a Multi-Link Link IE that comprises a Link ID Bitmap signaling which links of the plurality to tear down or to maintain active for the TDLS direct link. Similarly, the TDLS Setup Request frame may include one or more IEs signaling a new plurality of multiple setup communication links. The difference between this new plurality and the current plurality of links identifies which links to be modified (to open or to tear down).

In some embodiments, the method comprises, at a non-AP station or MLD:
receiving the TDLS Action frame signaling the two or more setup communication links, and
responding to the TDLS Action frame with a second TDLS Action frame signaling a subset only of the two or more communication links. Criteria to decide to reduce the set of communication links intended for the TDLS direct link can be specific to the non-AP station or MLD, e.g. based on which setup links the non-AP MLD actually operates on. The second TDLS Action frame is therefore send in response as a negotiating frame to agree on another set (subset) of TDLS links.

This possibility to dynamically adjust the set of TDLS links during the setup session advantageously reduces the amount of TDLS Action frames exchanged to achieve a TDLS direct link. In the context of the invention, the subset is preferably made of two or more communication links.

However, in some cases, e.g. when the non-AP station is a legacy station, the response only targets the first setup communication link mentioned above. When the non-AP station is a 802.11be single-radio station, the response may target any one of the signaled two or more setup communication links.

In some embodiments, the method further comprises at the non-AP MLD, once the TDLS direct link is established on a plurality of setup communication links, performing a direct link exchange with the other non-AP MLD over the links of the plurality. A direct link exchange means direct transmission of frames between two non-AP stations, without passing through the AP MLD or affiliated APs.

In particular, performing a direct link exchange may include sending a data frame directly to the other non-AP MLD over one of the links, the data frame having a MAC header in which a receiving address, RA, field is set to a MAC address of an affiliated station of the other non-AP MLD that corresponds to the link. Thanks to the signaling according to the invention, the non-AP MLDs have knowledge of the MAC addresses of the affiliated stations of the peer partner. By using such MAC addresses specific to the affiliated stations rather than the MLD MAC address of the non-AP MLD, this configuration simplifies the handling of received frames at the receiving non-AP MLD.

Correlatively, embodiments of the invention also provide a wireless communication device comprising at least one microprocessor configured for carrying out any method as described above.

Embodiments of the invention also provide a Tunneled Direct Link Setup, TDLS, Action frame used to establish a TDLS direct link between non-AP stations or MLDs, comprising one or more information elements, IEs, signaling two or more of the multiple setup communication links, on which to establish the TDLS direct link. All or part of the various IEs described above may be included in such frame.

Another aspect of the invention relates to a non-transitory computer-readable medium storing a program which, when executed by a microprocessor or computer system in a wireless device, causes the wireless device to perform any method as described above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

The names of the IEs as provided in the present document intend to reflect those currently used in the 802.11 standards in order to facilitate the reading of the document. Of course, any other naming carrying the same information can be used alternatively.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions between MLDs in which a single link Tunneled Direct Link Setup, TDLS, direct link is established;

FIG. 1a illustrates an exemplary 802.11be multi-link reference model for a MLD either AP MLD or non-AP MLD;

FIG. 2 illustrates, using frame exchanges in a timeline, a possible scenario for an initiator peer non-AP STA to handle P2P traffic;

FIG. 3 illustrates the format of 802.11 Action frames according to the 802.11 standards;

FIG. 4a illustrates a so-called “Link Identifier” IE according to the 802.11 standards;

FIG. 4b illustrates a so-called “TDLS Multi-Link” IE according to the 802.11 standards;

FIG. 4c illustrates a so-called “Multi-Link Link” IE according to the 802.11 standards;

FIG. 5 illustrates, using a flowchart, general steps to manage a multi-link TDLS direct link according to the embodiments of the invention;

FIG. 6 illustrates some IEs contained in the Action field of a TDLS Teardown frame according to the embodiments of the invention;

FIG. 7 schematically illustrates a multi-link TDLS direct link according to the embodiments of the invention, reusing the scenario of FIG. 1;

FIG. 8a illustrates first embodiments of the invention to signal multiple TDLS links in TDLS Action frames when establishing a multi-link TDLS direct link;

FIG. 8b illustrates second embodiments of the invention to signal multiple TDLS links in TDLS Action frames when establishing a multi-link TDLS direct link;

FIG. 8c illustrates third embodiments of the invention to signal multiple TDLS links in TDLS Action frames when establishing a multi-link TDLS direct link;

FIG. 8d illustrates fourth embodiments of the invention to signal multiple TDLS links in TDLS Action frames when establishing a multi-link TDLS direct link;

FIG. 9 illustrates exemplary steps of wireless communications involving TDLS at a TDLS initiator non-AP MLD, in accordance with embodiments of the present invention;

FIG. 10 illustrates exemplary steps of wireless communications involving TDLS at a TDLS responder non-AP station or MLD, in accordance with embodiments of the present invention;

FIG. 11a illustrates, using a frames sequence, a Multi-Link TDLS Discovery procedure according to embodiments of the invention;

FIGS. 11b and 11c illustrate, using a frames sequence, a Multi-Link TDLS Setup procedure according to embodiments of the invention;

FIG. 11d illustrates the transmission of a TDLS Setup Confirm frame according to embodiments of the invention;

FIG. 11e illustrates, using a frames sequence, an exemplary frame exchange over a multi-link TDLS direct link according to embodiments of the invention;

FIG. 12a shows a schematic representation a communication device according to at least one embodiment of the present invention; and

FIG. 12b illustrates schematically the architecture of the communication device of FIG. 12a.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or STAs. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., STAs). In some aspects, a wireless device or STA implemented in accordance with the teachings herein may comprise an access point (so-called AP) or not (so-called non-AP STA or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP STA may comprise, be implemented as, or known as a subscriber STA, a subscriber unit, a mobile STA (MS), a remote STA, a remote terminal, a user terminal (UT), a user agent, a user device, user equipment (UE), a user STA, or some other terminology. In some implementations, a STA may comprise a cellular telephone, a cordless telephone, a Session Initiation Protocol (“SIP”) phone, a wireless local loop (“WLL”) STA, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA may be a wireless node. Such wireless node may provide, for example, connectivity for or to a network (e.g., a wide area network such as the Internet or a cellular network) via a wired or wireless communication link.

An AP manages a set of STAs (registered to it or associated with it) that together organize their accesses to the wireless medium for communication purposes. The STAs (including the AP to which they register) form a service set, here below referred to as basic service set, BSS (although other terminology can be used). A same physical STA acting as an access point may manage two or more BSS (and thus corresponding WLANs): each BSS is thus uniquely identified by a specific basic service set identification, BSSID and managed by a separate virtual AP implemented in the physical AP. Each STA is identified within a BSS thanks to an identifier, AID, assigned to it by the AP upon registration.

The 802.11 family of standards define various media access control (MAC) mechanisms to drive access to the wireless medium.

The current discussions in the task group 802.11be, as illustrated by draft IEEE P802.11be/D2.0 of May 2022, introduce the Multi-Link Operation (MLO) when it comes to MAC layer operation. The MLO allows multi-link devices to establish or setup multiple links and operate them simultaneously. Those links are referred to as “setup links” or “setup communication links”.

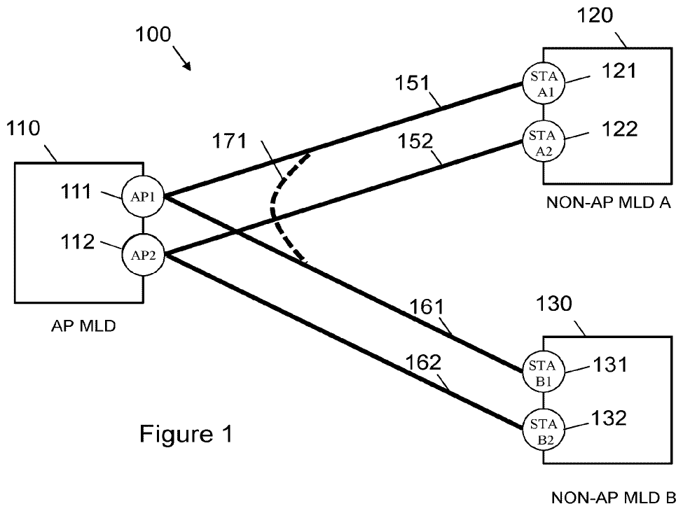

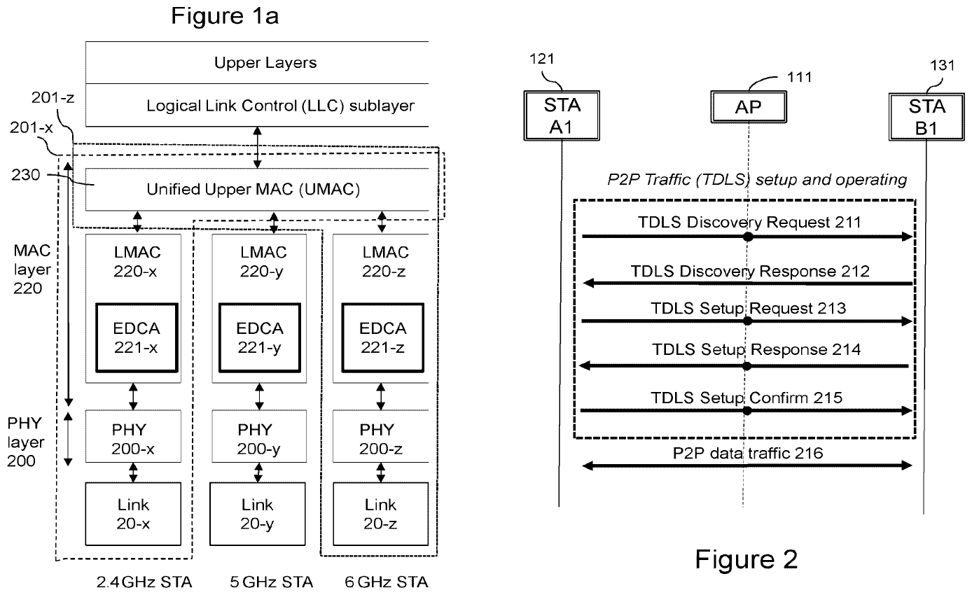

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as “affiliated AP”. A non-Access Point Multi-Link Device (or non-AP MLD) corresponds to a MLD where each STA affiliated with the MLD is a non-AP STA, referred to as “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device. An illustrative architecture of a Multi-Link Device is described below with reference to FIG. 1a.

A multi-link logical MAC address of an MLD may be a MAC address that uniquely identifies the MLD entity, which manages the affiliated STA entities. The multi-link logical MAC address may be referred to as an “MLD MAC address”, which may be a non-AP MLD MAC address or an AP MLD MAC address. The MLD MAC address may be a globally unique MAC address within the MLD considered or a MAC address that is shared with one of its affiliated STA entities. The affiliated STA entities (AP or STA) of an MLD have different per-link MAC addresses or “STA MAC addresses”.

Multiple affiliated non-AP STAs of a non-AP MLD can then setup communication links with multiple affiliated APs of an AP MLD, hence forming a multi-link channel.

The communication links (or “enabled links”) setup for MLDs are theoretically independent, meaning that the channel access procedure (to the communication medium) and the communication are performed independently on each link. Hence, different setup communication links may have different data rates (e.g. due to different bandwidths, number of antennas, etc.) and may be used to communicate different types of information (each over a specific link).

A setup communication link or enabled link or merely “link” thus corresponds to a given channel (e.g. 20 MHz, 40 MHz, and so on) in a given frequency band (e.g. 2.4 GHZ, 5 GHZ, 6 GHz) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated STAs but not necessary a number equal to its number of affiliated STAs. In particular, a non-AP MLD may operate with a number of affiliated STAs greater than its number of radios (which can even be reduced to a single one).

FIG. 1 illustrates a typical 802.11 network environment involving ML transmissions between MLDs in which a single link Tunneled Direct Link Setup, TDLS, direct link according to the D2.0 standard can be established.

Wireless communication network 100 involves an AP MLD 110 and two non-AP MLDs 120 and 130. Of course, another number of non-AP MLDs registering to the AP MLD 110 and then exchanging frames with it may be contemplated.

One of the two non-AP MLDs may be a legacy 802.11 station. In that case, the “affiliated non-AP STA” mentioned below merely refer to the legacy station itself.

AP MLD 110 has multiple affiliated APs, two affiliated APs 111 and 112 (also referenced AP1, AP2 respectively) in the exemplary FIG. 1, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP STAs, each of which behaves as an 802.11 non-AP STA in a BSS (managed by an affiliated AP 111 or 112) to which it registers. In the exemplary FIG. 1, two non-AP STAs 121 and 122 (also referenced A1 and A2 respectively) are affiliated with non-AP MLD 120 and two non-AP STAs 131 and 132 (also referenced B1 and B2 respectively) are affiliated with non-AP MLD 130.

Each affiliated AP offers a link towards the AP MLD 110 to the affiliated non-AP STAs of a non-AP MLD (120 or 130). Hence, the links for each non-AP MLD can be merely identified with the identifiers of the respective affiliated APs. In this context, each of the affiliated APs 111 and 112 can be identified by an identifier referred to as “Link ID”. The Link ID of each affiliated AP is unique and does not change during the lifetime of the AP MLD. AP MLD may assign the Link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP STA of the non-AP MLD. Each of such setup communication links, referred to as “enabled link”, enables individual channel access and frame exchanges between the non-AP MLD and the AP MLD based on supported capabilities exchanged during association.

The discovery phase is referred to as ML discovery procedure, and the multi-link setup phase (or association phase) is referred to as ML setup procedure. Management frames exchanged with the AP MLD during the ML discovery and ML setup procedures contain a new Information Element specific to the Multi-Link Operation (MLO), referred to as Basic Multi-Link element, which conveys a description of the affiliated STA entities of the MLD sending the frame that are additional to the sending affiliated STA entity (known as “reporting STA”). More precisely, the profile of the reporting STA is provided in Information Elements, IEs, of the frame outside the Basic Multi-Link element. And, the Basic Multi-Link element carries one or more Per-STA Profile subelement(s) corresponding to each additional affiliated STA (known as “reported STA”).

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate setup links between its own affiliated non-AP STAs and some of the discovered affiliated APs and to request the AP MLD 110 to set up these links, which may be accepted or refused by the AP MLD. If the AP MLD accepts, the non-AP MLD is provided with an Association Identifier (AID) by the AP MLD, which AID is used by the affiliated non-APs of the non-AP MLD to wirelessly communicate over the multiple setup communication links (communication channels) with their corresponding affiliated APs. During the ML setup procedure, the non-AP MLDs declare part or all of their capabilities.

For instance, they may declare their Tunneled Direct Link Setup (TDLS) capability, which enables devices (called TDLS peer STAs) to communicate directly to one another when connected to a traditional AP. For this, appropriate fields are provided in the management frames. De facto, in all Management frames, a non-AP MLD which may act as TDLS initiator STA or TDLS responder STA (dot11TunneledDirectLinkSetupImplemented to true) sets the TDLS Support bit (bit 37) in the Extended Capabilities element to 1.

For illustrative purpose, in wireless communication network 100, during the ML setup procedures, two candidate setup links have been requested by non-AP MLD 120 and accepted by AP MLD 110: a first link 151 between affiliated AP 111 (AP1) and affiliated non-AP STA 121 (A1), a second link 152 between affiliated AP 112 (AP2) and affiliated non-AP STA 122 (A2). Similarly, two candidate setup links have been requested by multi-radio non-AP MLD 130 and accepted by AP MLD 110: a first link 161 between affiliated AP 111 (AP1) and affiliated non-AP STA 131 (B1), a second link 162 between affiliated AP 112 (AP2) and affiliated non-AP STA 132 (B2).

As mentioned above, a different number of setup communication links per non-AP MLD may be contemplated. In some embodiments, the non-AP entity B may be a mere legacy 802.11 station in which case a single communication link exists with either AP1 or AP2 (depending on the operation channel).

A non-AP MLD, such as MLD A 120, that has performed multi-link setup with AP MLD 110 can establish a single link TDLS direct link on one of its links with MLD B (or legacy station B) 130. This means that two or more single link TDLS direct links can be established between the same non-AP MLDs, using respectively two or more of their setup communication links.

Reference 171 in the Figure illustrates a single link TDLS direct link that, when established, allows MLD A 120 (through affiliated STA A1 121) and MLD B 130 (through affiliated STA B1 131) to directly exchange data without relay by AP MLD 110.

FIG. 1a illustrates an exemplary 802.11be multi-link reference model for a MLD either AP MLD or non-AP MLD.

The MLD comprises a PHY layer 200, a MAC layer 220, a logical link control (LLC) sublayer and upper layers.

Upper layers may include applications that generate traffic data or use received traffic data.

The transmission and the reception of the traffic data are handled by the MAC 220 and PHY 200 layers. Such transmission and the reception of the traffic data may take place over multiple links 20-x, 20-y, 20-z, as the ones 151, 152, 161, 162 introduced with reference to FIG. 1, as well as over single link TDLS direct link 171 when established.

Three links and therefore three affiliated stations are shown in the Figure. Of course, other configurations including two affiliated stations or more than three affiliated stations may be contemplated.

The traffic data are provided by the upper layers as a sequence of data frames, or “traffic stream”. Each traffic stream and thus each data frame is associated with an access category (AC) as defined in the EDCA mechanism.

The data frames, also known as MAC service data units (MSDUs), incoming from an upper layer of the protocol stack are mapped, by a classifier, onto one of the four ACs and thus input in a queue of the mapped AC for transmission.

The 802.11be multi-link reference model reflects the fact that MLDs may transmit and receive using several links, particularly at the level of the MAC layer 220 and the PHY layer 200.

The MAC layer 220 comprises one Unified Upper-MAC (UMAC) layer 230, multiple Lower-MAC (LMAC) layers 220-x, 220-y, 220-z coupled with a respective PHY layer 200-x, 200-y, 200-z, each couple corresponding to a link 20-x, 20-y, 20-z.

The UMAC 230 performs functionalities that are common across all links and each LMAC 220-x, 220-y, 220-z performs functionalities that are local to each link 20-x, 20-y, 20-z. The UMAC layer then offers a UMAC interface with the link-specific blocks 220-x, 220-y, 220-z and also provides a UMAC Service Access Point (SAP) to the LLC and upper layers.

The UMAC 230 is responsible for link-agnostic MAC procedures such as authentication, association, security association, sequence number assignments, MAC Protocol Data Unit (MPDU) encryption/decryption, aggregation/de-aggregation, acknowledgement score boarding procedure, etc.

Each data unit, MSDU, arriving at the MAC layer 220 from an upper layer (e.g. Link layer) with a type of traffic (User Priority (UP) hence Traffic Identifier (TID)) priority is mapped onto one of the ACs according to the mapping rule at the UMAC layer 230. Then, still at the UMAC layer 230, the data unit, MSDU, is provided with the next sequence number available and is stored in the queue corresponding to its TID (or UP) within the mapped AC.

The UMAC 230 is provided with a MLD MAC address uniquely identifying the MLD as a whole.

Each LMAC 220-x, 220-y, 220-z is in charge of link specific functionalities like the channel access. In particular, each MLD Lower MAC includes its own contention-based channel access procedure. Some of the functionalities require joint processing of both the UMAC 230 and LMACs 220-x, 220-y, 220-z.

Each LMAC 220-x, 220-y, 220-z is provided with a dedicated STA MAC address to communicate over its respective link or channel. One of the STA MAC address may be equal to the MLD MAC address of the MLD, or all the STA MAC addresses may be different one from the other and from the MLD MAC address.

The affiliated STA entities 111-121-131 (idem 112-122-132) compete one against each other on their common channel using a conventional EDCA (Enhanced Distributed Channel Access) contention scheme, to access the wireless medium in order to be granted a transmission opportunity (TXOP) and then to transmit (single-user, SU) data frames. The affiliated STAs 121-131 (idem 122-132) may also use a multi-user (MU) scheme in which the affiliated AP 111 (idem 112) of the AP MLD 110 is allowed to schedule a MU transmission, i.e. multiple simultaneous transmissions to or from the stations of its BSS, in the wireless network. One implementation of such a MU scheme has been for example adopted in IEEE Std 802.11ax-2021 standard, as the Multi-User Uplink and Downlink OFDMA (MU UL and DL OFDMA) procedures.

The single link TDLS direct link mechanism in the context of MLDs in now explained with reference to FIG. 2 which illustrates, using frame exchanges in a timeline, a possible scenario for an initiator peer non-AP STA (affiliated non-AP STA) to handle P2P traffic.

This example involves STA A1 121 as the initiator for the P2P communication and STA B1 131 as the partner or responder for the P2P communication 171. They both take part of the same BSS (identified by BSSID1) on a given link 1 (151/161), and are associated with AP 111. As mentioned above, STA A1 and STA B1 may be non-AP stations affiliated with respective non-AP MLDs, while AP 111 may be an AP affiliated with an AP MLD 110.

In the sequence, once STA A1 and STA B1 are associated with the AP (association not shown), they can exchange data over their operation link through the AP.

To reduce the amount of traffic that is transferred in the network and prevent congestion at the AP, the IEEE 802.11z amendment has defined mechanisms, known as Tunneled Direct Link Setup (TDLS), that allow the 802.11 non-AP stations to set up a direct link between them, while also remaining associated with the AP. The D2.0 standard upgrades the conventional TDLS mechanism to work with the multi-link feature.

Tunneled direct-link setup (TDLS) is characterized by the use of signaling frames that are encapsulated in 802.11 Data frames so that the signaling frames are transmitted through the AP transparently. Therefore, the AP does not need to be direct-link aware, nor does it have to support the same set of capabilities that are used on the direct link, in order for TDLS to be used.

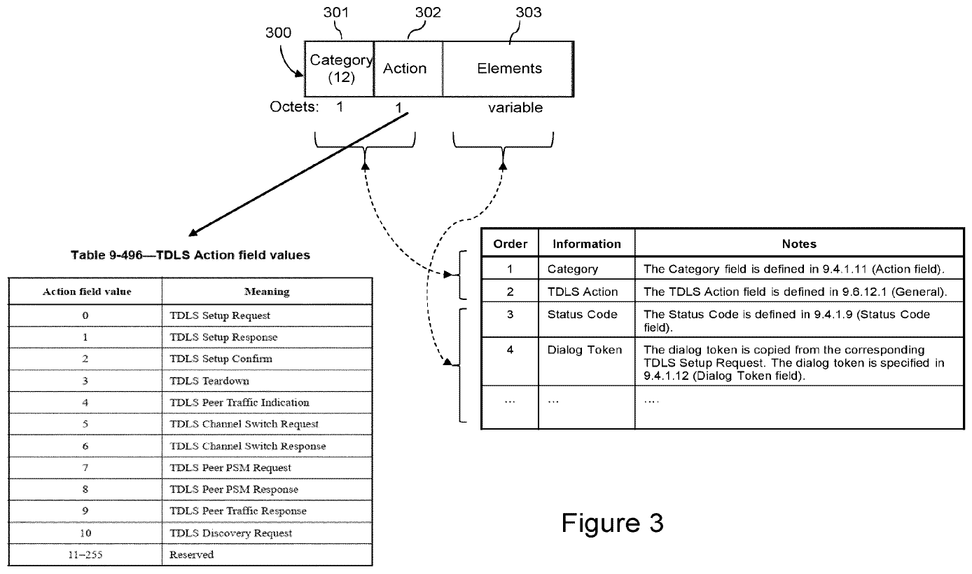

In the sequence shown, a TDLS session or “TDLS direct link” is established between STA A1 and STA B1 (either of both can be the initiator of the TDLS direct link establishment). The establishment may include a TDLS discovery procedure (optional) and a TDLS setup procedure. TDLS discovery and setup procedures between STA A1 and STA B1 involve frames, known as TDLS Action frames, that are usually sent and received via intermediate AP 111. FIG. 3 illustrates the format of 802.11 Action frames 300. The Figure only shows the payload of such Action frames, the MAC header being omitted for conciseness.

An Action frame 300 has the format of a frame, hence has a Category field 301, an Action field 302 immediately after the Category field 301 and an Elements field 303.

Various values of the Category field 301 are defined in the 802.11 standard, corresponding to various Actions frames. Category field set to 12 defines a TDLS Action frame, while Category field set to 4 defines a Public Action frame.

TDLS Action frames conveys TDLS signaling. 1-byte Action field 302 for a TDLS Action frame may take various values from 0 to 10 (11 to 255 being reserved), as shown in Table 9-496 of the 802.11 Standard (as example, IEEE P802.11-REVme™/D1.0, December 2021) and reproduced in the Figure, to signal different types of TDLS Action frames having each its own function in the TDLS mechanism. For example, TDLS Setup Request frame 213 is identified by Action field 302 set to 0; TDLS Setup Response frame 214 by Action field 302 set to 1; and TDLS Setup Confirm frame 215 by Action field 302 set to 2.

Elements field 303 comprises various Information Elements, IEs, describing parameters for the TDLS Action.

Back to FIG. 2, when attempting to discover TDLS stations in the same BSS, a series of frame exchanges is used. STA A1, which is the initiator in the proposed scenario, sends a TDLS Discovery Request frame 211, tunneled through AP 111 (relay illustrated by the black dot), to an individual destination station, here STA B1.

This request frame conveys so-called “Link Identifier” element and “TDLS Multi-Link” element amongst the IEs of the Elements field 303. Other IEs forming the Elements field 303 are defined in Table 9-507 as defined in IEEE 802.11-REVme/D1.3 (June 2022).

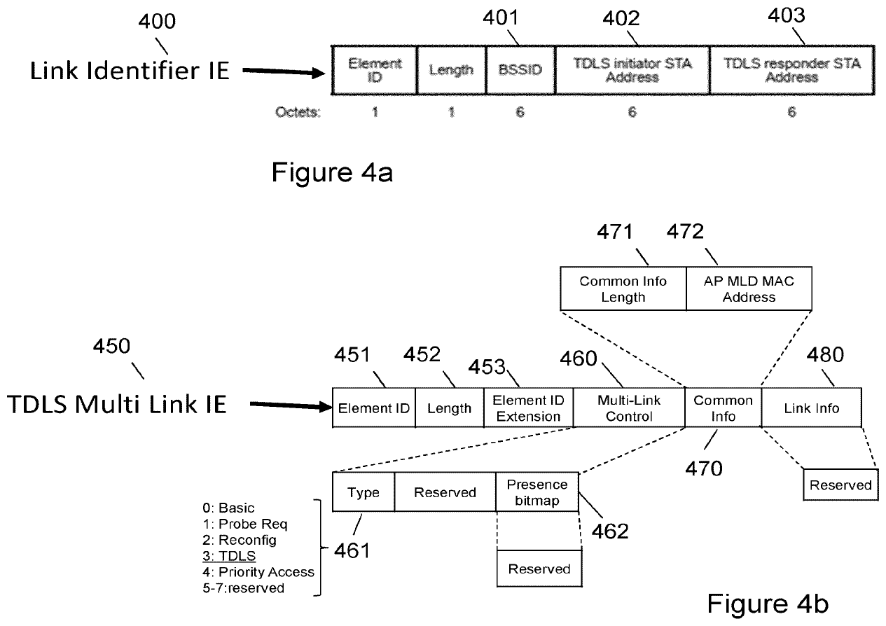

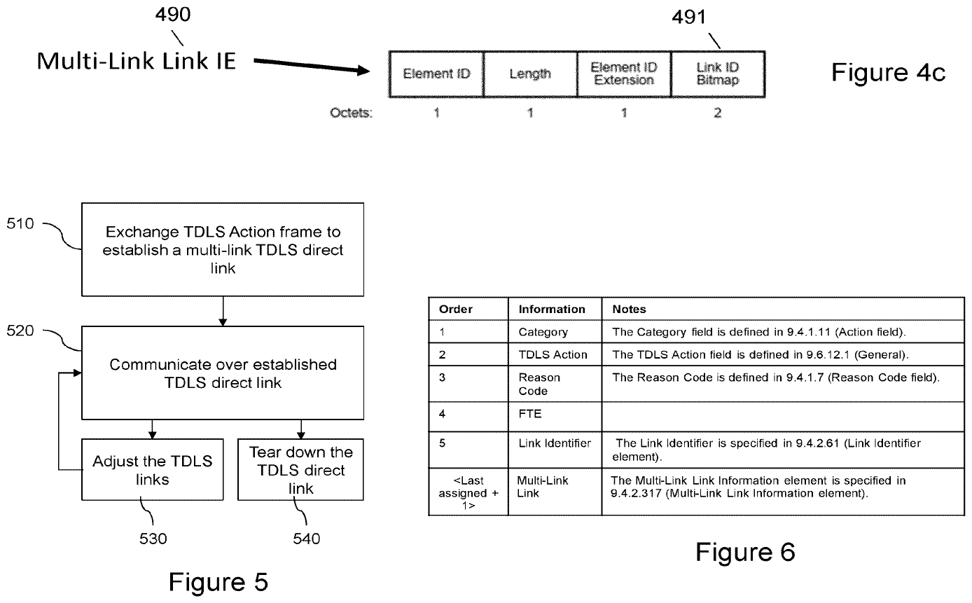

The Link Identifier element is shown in FIG. 4a under reference 400. It includes a BBSID field 401, a TDLS initiator STA address field 402 and a TDLS responder STA address field 403. The BSSID field 401 is set to the BSSID of the BSS of which TDLS initiator STA A1 is a member, BSSID1 in the example as it corresponds to the affiliated AP AP1 111 with which TDLS initiator STA A1 is associated. The TDLS initiator STA Address field 402 is set to the TDLS initiator's MAC address, which is the MLD MAC address of MLD A 120 in the context of MLD operations. The TDLS responder STA Address field 403 is set to the TDLS responder's MAC address, which is the MLD MAC address of MLD B 130 in the context of MLD operations.

Such Link Identifier element is present in any type of TDLS Action frame. The MLD MAC address in the Link Identifier element therefore allows the STAs to recognize each other as the MLD MAC address of an MLD is its identity known by the wireless communication network 100. The BSSID allows the STAs to identify the setup communication link for TDLS operation.

The TDLS Multi-Link element is shown in FIG. 4b under reference 450. It is based on the structure of Multi-Link element introduced for supporting several links (e.g. Basic version is used for association of MLDs), and is therefore composed of:
an Element ID 451 equal to 255,
a Length field 452 defining the length of the Information Element,
an Element ID extension field 453 set to 107 identifying a multi-link IE,
a Multi-link Control field 460 allowing the type of the multi-link IE to be defined as TDLS (value: 3) within the Type field 461,
a Common Info field 470 containing a Common Info Length field 471 and an AP MLD MAC address field 472 set to the MLD MAC address of the AP MLD with which the TDLS initiator non-AP MLD is associated,
a Link info field 480 is reserved (that means not used).

As a result, the TDLS Multi-Link IE allows the initiator non-AP MLD to share the AP MLD MAC address of the AP MLD in the multi-link environment. The responder non-AP MLD can thus check it is associated with the same AP MLD. In other words, an affiliated STA will only consider a TDLS Action frame if the frame carries a TDLS Multi-Link element 450 and the MLD MAC address carried in the AP MLD MAC Address field 472 of the TDLS Multi-Link element 450 matches the MLD MAC address of the AP MLD with which the non-AP MLD has already performed a multi-link setup.

This is the case for MLD B in the scenario of FIG. 2.

Destination station STA B1 responds to the TDLS Discovery Request frame 211 with a TDLS Discovery Response frame 212, sent directly to STA A1 (without relay by AP 111). This response frame conveys a “Link Identifier” element and a “TDLS Multi-Link” element amongst the IEs of the Elements field 303. Other IEs forming the Elements field 303 are defined in Table 9-457 as defined in IEEE 802.11-REVme/D1.3 (June 2022).

From that point, STA A1 and STA B1 know each other, meaning they know the other operates on the communication link setup with AP 111. They can then establish a TDLS direct link.

When attempting to establish a TDLS direct link over a single link with the discovered TDLS station, a series of TDLS Action frame exchanges is used to set up the single link TDLS direct link.

TDLS initiator STA A1 first sends a TDLS Setup Request frame 213, tunneled through AP 111, to target TDLS responder STA B1. This request frame conveys a “Link Identifier” element and a “TDLS Multi-Link” element amongst the IEs of the Elements field 303. Other IEs forming the Elements field 303 are defined in Table 9-497 as defined in IEEE 802.11-REVme/D1.3 (June 2022), which include information about the capabilities of TDLS initiator STA A1 and an AID thereof.

TDLS responder STA B1 responds with a TDLS Setup Response frame 214, also tunneled through AP 111. This response frame conveys a “Link Identifier” element and a “TDLS Multi-Link” element amongst the IEs of the Elements field 303. Other IEs forming the Elements field 303 are defined in Table 9-498 as defined in IEEE 802.11-REVme/D1.3 (June 2022), which include information about the capabilities of TDLS responder STA B1, its AID plus a status code that either accepts or rejects the setup request.

If the Setup Request is accepted, TDLS initiator STA A1 then sends a confirmation, TDLS Setup Confirm frame 215, still tunneled through AP 111. This confirmation frame conveys a “Link Identifier” element and a “TDLS Multi-Link” element amongst the IEs of the Elements field 303. Other IEs forming the Elements field 303 are defined in Table 9-499 as defined in IEEE 802.11-REVme/D1.3 (June 2022).

This concludes the TDLS setup handshake. At this point, the two non-AP MLDs know the identity of the other on the one hand with their MLD MAC address and on the other hand with the AID assigned by the AP MLD.

The stations can then start to communicate directly over link 171 (direct link): P2P traffic 216 can then be directly (not black dot shown at the AP in the Figure for arrow 216) exchanged between STA A1 and STA B1 using the established TDLS session. TDLS peers STA A1 and STA B1 are then configured to accept Data frames received directly from the other peer. The frame exchanges are performed over the same link, that is to say the same frequency channel so that this P2P traffic becomes concurrent to other traffic for AP 110.

Table 399 below is provided for illustrative purposes only, to show exemplary IEs of the Elements fields 303 to be provided in TDLS Setup Action frames (i.e. with Action field 302 set to 0.1 or 2). Each type of TDLS Action frame has its own set of elements 303 to be provided to identify the frame (Category, TDLS Action and Dialog Token as defined in the standard).

The Action field of a TDLS Setup Request Action field contains the information shown below, whereas the corresponding TDLS Setup Response Action field only contains the information if Status Code is SUCCESS.

TABLE 399

| IE | Notes |
|---|---|
| Capability | The Capability field indicates the |
| | capabilities of the STA. The Capability |
| | field is defined in 9.4.1.4 (Capability |
| | Information field). |
| Supported | The Supported Rates and BSS Membership |
| Rates and | Selectors element indicates the rates that |
| BSS | are supported by the STA. The Supported |
| Membership | Rates and BSS Membership Selectors |
| Selectors | element is defined in 9.4.2.3 (Supported |
| | Rates and BSS Membership Selectors |
| | element). |
| Country | The Country element is present when |
| | dot11MultiDomainCapabilityActivated is |
| | true or |
| | dot11SpectrumManagementRequired is |
| | true. The Country element is defined in |
| | 9.4.2.8 (Country element). |
| Extended | The Extended Supported Rates and BSS |
| Supported | Membership Selectors element is present if |
| Rates and | there are more than eight supported rates |
| BSS | and BSS membership selectors, and it is |
| Membership | optionally present otherwise. The Extended |
| Selectors | Supported Rates and BSS Membership |
| | Selectors element is defined in 9.4.2.12 |
| | (Extended Supported Rates and BSS |
| | Membership Selectors element). |
| Supported | The Supported Channels element is present |
| Channels | if the TDLS Channel Switching subfield is |
| | equal to 1. |
| | The Supported Channels element is defined |
| | in 9.4.2.17 (Supported Channels element). |
| RSNE | The RSNE is present if security is required |
| | on the TDLS direct link (see 12.7.8.1 |
| | (General)). The RSNE is defined in |
| | 9.4.2.24 (RSNE). |
| Extended | The Extended Capabilities element is |
| Capabilities | present if any of the fields in this element |
| | are nonzero. The Extended Capabilities |
| | element is defined in 9.4.2.26 (Extended |
| | Capabilities element). |
| QoS | The QoS Capability element is present |
| Capability | when dot11QosOptionImplemented is true |
| | and not present otherwise. The QoS |
| | Capability element is defined in 9.4.2.34 |
| | (QoS Capability element). |
| FTE | The FTE (Fast BSS Transition element) is |
| | present if security is required on the TDLS |
| | direct link (see 12.7.8.1 (General)). The |
| | FTE is defined in 9.4.2.47 (Fast BSS |
| | Transition element (FTE)). |
| Timeout | The Timeout Interval element contains the |
| Interval | TPK key lifetime and is present if security |
| (TPK key | is required on the TDLS direct link (see |
| lifetime) | 12.7.8.1 (General)). |
| | The Timeout Interval element is defined in |
| | 9.4.2.48 (Timeout Interval element (TIE)). |
| Supported | The Supported Operating Classes element |
| Operating | is present if the TDLS Channel Switching |
| Classes | subfield is equal to 1. (see 9.4.2.53 |
| | (Supported Operating Classes element)) |
| HT | The HT Capabilities element is defined in |
| Capabilities | 9.4.2.55 (HT Capabilities element). |
| | The HT Capabilities element is present when |
| | dot11HighThroughputOptionImplemented |
| | is true. |
| 20/40 BSS | The 20/40 BSS Coexistence element is |
| Coexistence | defined in 9.4.2.59 (20/40 BSS Coexistence |
| | element). |
| | The 20/40 BSS Coexistence element is |
| | optionally present. |
| Link | The Link Identifier element is specified in |
| Identifier | 9.4.2.61 (Link Identifier element). |
| Multi-band | The Multi-band element is optionally |
| | present if dot11MultibandImplemented is |
| | true. |
| AID | The AID element containing the AID of the |
| | STA or non-AP |
| | MLD whose affiliated STA is sending the |
| | frame is present if |
| | dot11VHTOptionImplemented, |
| | dot11HEOptionImplemented, |
| | dot11EHTOptionImplemented or |
| | dot11S1GOptionImplemented |
| | is true. |
| VHT | The VHT Capabilities element is present if |
| Capabilities | dot11VHTOptionImplemented is true. |
| S1G | S1G Capabilities element is optionally |
| Capabilities | present if dot11S1GOptionImplemented is |
| | true. |
| EL | EL Operation element is present if |
| Operation | dot11S1GELOperationActivated is true. |
| HE | The HE Capabilities element is present if |
| Capabilities | dot11HEOptionImplemented is true; |
| | otherwise, it is not present. The HE |
| | Capabilities element is defined in 9.4.2.248 |
| | (HE Capabilities element(11ax)). |
| TWT | The TWT element is optionally present if |
| | dot11TWTOptionActivated is true; |
| | otherwise, it is not present. |
| | The Trigger subfield and the Negotiation |
| | Type subfield of the TWT element are set |
| | to 0. |
| HE 6 GHz | The HE 6 GHz Band Capabilities element |
| Band | is present if dot11HEOptionImplemented |
| Capabilities | and dot11HE6GOptionImplemented are |
| | true; otherwise, it is not present. |
| EHT | The EHT Capabilities element is present if |
| Capabilities | dot11EHTOption- Implemented is true; |
| | otherwise it is not present. |
| TDLS | The TDLS Multi-Link element is present if |
| Multi-Link | the STA is affiliated with a non-AP MLD; |
| | otherwise, it is not present. |

The Action field of a TDLS Setup Confirm Action field may contain a subset of this list, where Capabilities IEs are replaced by Operation IEs (e.g. HT/VHT/HE/EHT Capabilities IEs are replaced by HT/VHT/HE/EHT Operation IEs).

The Action field of a TDLS Discovery Action field may contain a subset of this list, basically a Link Identifier IE, a TDLS Multi-Link IE and a Multi-Band IE (defined in Table 9-507 of IEEE 802.11-REVme/D1.3-June 2022).

As a result, the D2.0 standard allows direct link communications between non-AP MLDs with one or more single link TDLS direct links. It means separate and independent TDLS sessions can be established on multiple links via multiple affiliated STAs of the same non-AP MLDs.

This state of the art is not satisfactory.

Establishing several separate single link TDLS direct links in between two non-AP MLDs requires a lot of frame transmission. It would be beneficial to reduce this traffic overhead.

In addition, multi-link aggregation and/or other features of MLO are no longer supported with such multiple single link TDLS direct links. As an example, a block acknowledgement session is performed on a TDLS direct link basis, meaning as many block acknowledgement sessions as the number of single link TDLS direct links established between the two non-AP MLDs are required. It would be beneficial to benefit from the multi-link features (aggregation, common block acknowledgement session, common retransmission through plural links) within a single link TDLS direct link.

The present invention offers solutions to this deficient situation by providing a TDLS setup over multiple communication links to ultimately establish, when possible, a multi-link TDLS direct link between non-AP MLDs. This is accomplished by providing one or more of the TDLS Action frames exchanged during the TDLS direct link establishment, with a signaling of two or more of the multiple setup communication links, on which to establish the TDLS direct link. As exemplified in embodiments below, such signaling can be made using information elements in the Element field 303 of the TDLS Action frames, e.g. TDLS Discovery and/or Setup frames.

As a consequence, the two non-AP MLDs may agree on two, three or even more setup communication links, also referred below as “TDLS links”, on which the multi-link TDLS direct link is established, in such a way the P2P communication in the TDLS session benefits from the multi-link features.

FIG. 5 illustrates, using a flowchart, general steps to manage a multi-link TDLS direct link according to the embodiments of the invention. The illustrated flowchart is implemented at both the TDLS initiator non-AP MLD and the TDLS responder non-AP MLD. It is assumed that the non-AP MLDs have set up multiple communication links with the AP MLD.

At step 510, they exchange TDLS Action frames to establish a Tunneled Direct Link Setup, TDLS, direct link with each other. The TDLS initiator non-AP MLD sends the first TDLS

Action frame initiating the exchange of frames. The event triggering the process at the initiator may be of various nature, e.g. the detection of P2P traffic in the transmission buffers of the TDLS initiator non-AP MLD.

The step may optionally include exchanging a TDLS Discovery Request frame 211 and a TDLS Discovery Response frame 212.

The step includes exchanging a TDLS Setup Request frame 213, a TDLS Setup Response frame 214 and a TDLS Setup Confirm frame 215 as illustrated in FIG. 2.

TDLS Setup Request frame 213 includes one or more information elements, IEs, signaling two or more of the multiple setup communication links, on which to establish the TDLS direct link. The TDLS initiator non-AP MLD selects links amongst its own setup communication links with the AP MLD.

This signaling indicates the links to be used for the TDLS session (hence “TDLS links”), to the TDLS responder non-AP MLD. In a variant, they may be candidate links proposed to the TDLS responder, in which case a negotiation can start. TDLS Setup Response frame 214 may therefore also signal one or more multiple setup communication links, which are the above two or more TDLS links (to confirm they are accepted) or a subset thereof (as a negotiation to reduce the links). Reasons for a negotiation may be that one or more of the proposed candidate links are not setup communication links for the TDLS responder non-AP MLD.

Similarly, TDLS Setup Confirm frame 215 may also signal the final set of setup communication links (usually similar to those signaled in the TDLS Setup Response frame 214) to be used for the TDLS direct link session. In a variant, TDLS Setup Confirm frame 215 only comprises a status code, confirming or not the proposed TDLS links (in the TDLS Setup Request or Response frame).

In embodiments, the TDLS Discovery frames 211, 212 also signal proposed candidate links for the TDLS direct link session. This aims at making the TDLS Setup procedure smoother, with less risk of refusal, as the two non-AP MLDs already know the desired TDLS links for the other MLD.

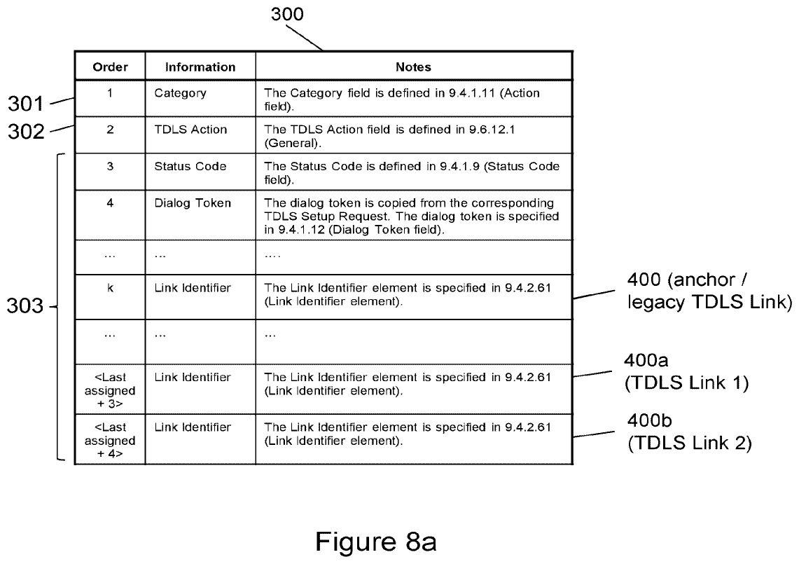

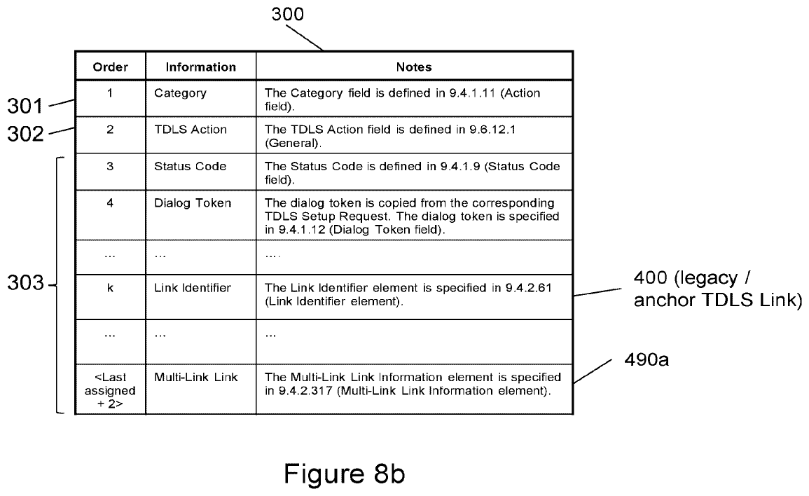

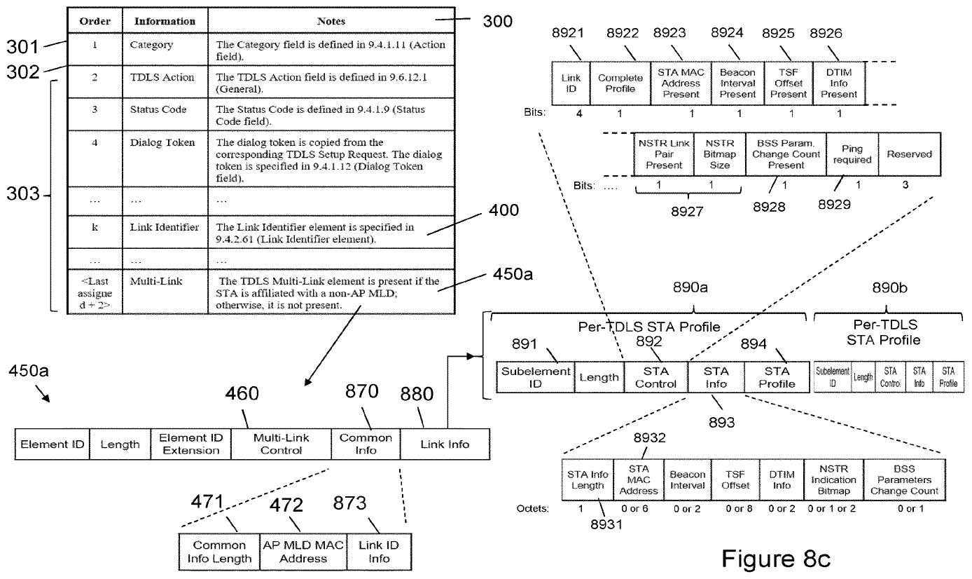

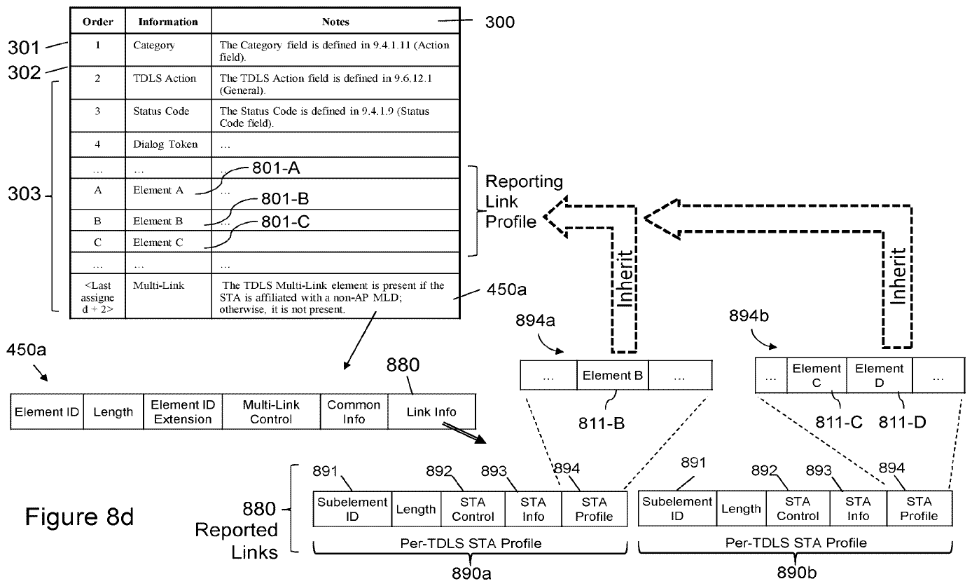

Various embodiments to signal multiple links for the TDLS direct link are proposed below with reference to FIGS. 8a to 8d.

Once the TDLS Action frames have been exchanged at step 510, a multi-link TDLS direct link is established between the two non-AP MLDs.

At step 520, they can operate the multi-link TDLS direct link by directly exchanging P2P traffic over the agreed two or more TDLS links.

In other words, once the TDLS direct link is established on a plurality of setup communication links, each non-AP MLD performs a direct link exchange with the other non-AP MLD over the links of the plurality.

During the lifetime of the multi-link TDLS direct link, there may be changes in network conditions or in P2P traffic that require an adaptation or adjustment of the multi-link TDLS direct link, in particular with respect to the set of its composing TDLS links.

At any time during the lifetime, at step 530, the two non-AP MLDs can decide to adjust the set of setup communication links forming the multi-link TDLS direct link. This may include adding one or more other setup communication links and/or removing one or more setup communication links from the current set.

Any of the two non-AP MLDs may initiate this adjustment.

In embodiments, step 530 consists for the non-AP MLDs in exchanging a TDLS Teardown frame signaling which TDLS links to add, to tear down or to maintain active for the multi-link TDLS direct link.

Those changing links may be signaled using the same signaling as described below for the TDLS Discovery and Setup frames.

As an example, the TDLS Teardown frame includes a Multi-Link Link IE that comprises a Link ID Bitmap signaling which links of the plurality of already established TDLS links to tear down (when reducing the set) or to maintain active for the TDLS direct link (in which case the other ones are torn down). The Multi-Link Link IE is described below in details with reference to FIG. 4c.

FIG. 6 illustrates some IEs contained in the Action field of such a TDLS Teardown frame according to the embodiments of the invention.

The first five IEs are those defined in Table 9-500 of IEEE 802.11-REVme/D1.3-June 2022.

The TDLS Teardown Action field is encapsulated in an 802.11 Data frame and transmitted to the other non-AP MLD (TDLS partner) directly or through the AP to tear down the TDLS direct link if the last IE, Multi-Link Link IE, is not present (the TDLS direct link is identified through the Link Identifier IE) or, if present, signals all the TDLS links of the multi-link TDLS direct link.

The TDLS Teardown frame modifies the set of TDLS links forming the multi-link TDLS direct link if the Multi-Link Link IE signals only a subpart of the links currently used. In other words, the Multi-Link Link IE lists the TDLS link(s) to teardown. In that case (Multi-Link Link IE is present), the Link Identifier IE is deprecated to avoid its conventional effect of tearing down the entire TDLS direct link.

The TDLS Teardown frame to adjust the set of links is sent through the AP or over the direct path (TDLS direct link) and the reason code can be set to a value such as TDLS_TEARDOWN_LINK_UNSPECIFIED_REASON (this is a new value as last entry in table 9-77 of IEEE 802.11-REVme/D1.3-June 2022).

Back to FIG. 5, once the set of setup communication links on which the multi-link TDLS direct link is established has been updated, the non-AP MLDs can continue to operate the multi-link TDLS direct link at step 520 with the new (adjusted) set of TDLS links.

Step 540 occurs when the multi-link TDLS direct link is to be ended. One of the two non-AP MLDs can send a TDLS Teardown frame as mentioned above, wherein no Multi-Link Link IE is present or such Multi-Link Link IE (if present) signals all the links of the multi-link TDLS direct link.

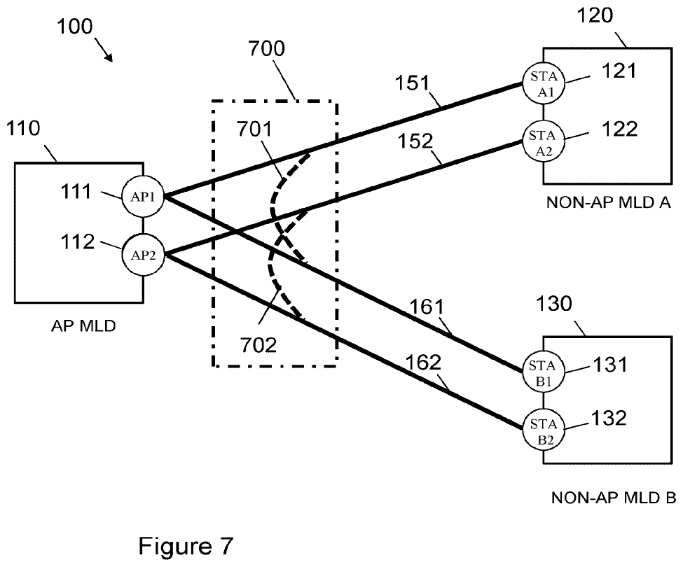

FIG. 7 schematically illustrates a multi-link TDLS direct link according to the embodiments of the invention, reusing the scenario of FIG. 1.

Non-AP MLD A 120 and non-AP MLD B 130 agree on establishing a multi-link TDLS direct link on their respective communication links 151/161 and 152/162, hence forming two TDLS links 701 and 702 within the same TDLS direct link. As illustrated through reference 700, these two TDLS links are closely linked as the non-AP MLD may use the multi-link features, such as aggregation, block acknowledgment, frame repetition, within the set formed of the two TDLS links.

Of course, two links are presented for the sake of illustration, but this is not limitative as a higher number of TDLS links may be contemplated on which one and the same multi-link TDLS direct link is established.

Turning now to the signaling of the multiple setup communication links in the TDLS Action frames to be used as TDLS links for a multi-link TDLS direct link, various embodiments are contemplated here below.

The frames can be TDLS request frames (such as a TDLS Discovery Request frame and/or a TDLS Setup Request frame and/or a TDLS Setup Confirm frame from a TDLS initiator station) or TDLS response frames (such as a TDLS Discovery Response frame and/or a TDLS Setup Response frame from a TDLS responder station). It is recalled that the signaled multiple TDLS links can be proposed or intended or candidate links, or be mandated links (when no negotiation is available).

First embodiments are illustrated in FIG. 8a. Second embodiments are illustrated in FIG. 8b. Third embodiments are illustrated in FIG. 8c. Fourth embodiments are illustrated in FIG. 8d.

In all these embodiments, the signaling TDLS Action frame includes a Link Identifier IE 400 (see FIG. 4a) to signal a first one of the multiple setup communication links, and one or more additional IEs to signal a second (or secondary) one or more of the multiple setup communication links. The various embodiments provides variants in the additional IEs.

By using the conventional Link Identifier IE, these embodiments provide backwards compatibility. In particular, it allows a non-AP MLD to initiate a TDLS session with a legacy 802.11 station (which does not implement multi-link features). In that case, the legacy 802.11 station only detects that Link Identifier IE (and not the additional IEs signaling other links), hence is able to establish a TDLS direct link on its single link available.

For ease of explanation below, this “first” setup communication link signaled in the conventional Link Identifier IE is referred to as “anchor” link. This is because it is the link “anchoring” the mechanism of the invention to the legacy mechanisms.

In one embodiment, the transmitting non-AP MLD may decide setting this conventional Link Identifier IE with the link over which it transmits. In other words, the first setup communication link (or anchor link) corresponds to the link over which the signaling TDLS Action frame is transmitted. This is, of course, not mandatory as the non-AP MLDs may use indifferently any of the setup communication channel to try to reach the other peer non-AP MLD. Hence, the anchor link may be a preferred setup communication link that is different from the link over which it transmits.

FIG. 8a illustrates first signaling embodiments in TDLS Action frames, wherein the frame includes a plurality or series of Link Identifier IEs 400, each signaling one of the multiple setup communication links.

The Figure shows exemplary IEs forming such a TDLS Action frame, with the Category field 301, the Action field 302 and the ordered set of IEs 303.

The latter includes a first occurrence of a Link Identifier IE which is the legacy Link Identifier 400 conveying the anchor or primary link that legacy 802.11 stations will only consider (contrary to the subsequent Link Identifier IEs). This “first” Link Identifier IE occupies its standardized position within the ordered set of IEs 303. As an example, this Link Identifier IE has the “order” equal to “18” in the TDLS Setup Request frame 213.

The subsequent Link Identifier IEs 400a, 400b are provided as new IEs at the end of the ordered set of IEs 303. As an example, these Link Identifier IEs have one or more “orders” from “25” in the TDLS Setup Request frame 213, which is the next order available. They may be provided as a list with the same order (in which case the list signals the number of IEs), or may be provided as distinct IEs with separate orders (a predefined number of subsequent Link Identifier IEs can therefore be provided in the standardized set 303).

The subsequent Link Identifier IEs are indicative of the other TDLS link(s) on which establishing the multi-link TDLS direct link. As mentioned above, they may be mandatory TDLS links or candidate ones in which case a subset thereof can be envisaged in the TDLS Setup/Discovery Response frame compared to the Request frame.

In the Figure, TDLS Link 1 is signaled through IE 400a while TDLS Link 2 is signaled through IE 400b. They are additional to anchor TDLS link signaled through IE 400. As exampled above with reference to FIG. 4a, all these IEs 400, 400a, 400b include the same TDLS initiator STA Address 402 (set to the MLD MAC Address of the initiator) and the same TDLS responder STA Address 403 (set to the MLD MAC Address of the responder), but differ one from each other by a different BSSID 401 which is the BSSID of the affiliated AP to which corresponds the link considered (e.g. anchor TDLS link may correspond to AP1 having BSSID1, while TDLS Link 1 corresponds to AP2 having BSSID2 and TDLS Link 2 corresponds to AP3 having BSSID3, all in the same AP MLD).

In the exemplary scenario of FIG. 7, as only two links are intended (corresponding to TDLS communication links 701 and 702 managed by the present Multi-Link TDLS procedure), only one subsequent Link Identifier 400a is present.

FIG. 8b illustrates second signaling embodiments in TDLS Action frames, wherein the frame includes a Multi-Link Link IE signaling the second one or more of the multiple setup communication links. This IE is additional to the conventional Link Identifier IE 400 signaling the anchor TDLS link.

The Multi-Link Link IE has been introduced above with reference to the TDLS Teardown frame. Its format is defined in the D2.0 standard as illustrated in FIG. 4c to originally signal on which links an individually addressed Management frame (MMPDU) is intended. The MMPDU is to be distributed via given link(s) different from the link(s) related to the Management information it includes (e.g. a possibility is also that information is intended for more than one STA/Link, or a retransmission is willing on a different STA . . . ). As shown in the Figure, the Multi-Link Link IE 490 can be identified through the Element ID and optionally Element ID Extension fields, and it identifies, through the Link ID Bitmap field 491, the intended link(s) of the MMPDU that carries the element. The Link ID Bitmap field indicates the link(s) where the intended STA(s) are operating on.

In the embodiments of FIG. 8b, Multi-Link Link IE 490a is positioned as a new IE at the end of the ordered set of IEs 303 as currently defined in the D2.0 standard. As an example, Multi-Link Link IE has the “order” equal to “25” in the TDLS Setup Request frame 213, which is the next order available.

Multi-Link Link IE 490a includes a Link ID Bitmap 491, the bits of which can be set to indicate the second one or more of the multiple setup communication links. For example, the first bit (b0) in the Bitmap may correspond to the link having a Link ID=0, the second bit (b1) in the Bitmap may correspond to the link having a Link ID=1, and so on. It is recalled that the Link ID values are unique per affiliated AP within the AP MLD 110.

The bitmap may signal or not the anchor TDLS link.

In other words, a Multi-Link Link Information element (490a) is included inside those frames. The Multi-Link Link Information element identifies the intended link(s) of the Multi-Link TDLS session, wherein the Link ID Bitmap field indicates the link(s) where the intended P2P STA(s) are operating TDLS on.

The value carried as the Link ID is unique to every AP affiliated with an AP MLD. As the two non-AP MLDs 120 and 130 are associated with the same AP MLD 110, the Link ID values are those indicated by the AP MLD (e.g. during multi-link setup).

In the exemplary scenario of FIG. 7, as only two links are intended (corresponding to TDLS communication links 701 and 702 managed by the present Multi-Link TDLS procedure), Multi-Link Link Information element 490a contains a bitmap having two bits set (or enabled) if the anchor TDLS link is also signaled in the bitmap, or contains a bitmap having a single bit set (or enabled) if the anchor TDLS link is not signaled in the bitmap.

FIG. 8c illustrates third signaling embodiments in TDLS Action frames, wherein the frame includes a Multi-Link IE 450a having a Type field set to TDLS, signaling the second one or more of the multiple setup communication links. Hence, Initiator STA of a first MLD and Responder STA of a second MLD may include a Multi-Link IE in a TDLS request/response frame to identify requested TDLS link(s) for direct link communications.

This IE 450a is additional to the conventional Link Identifier IE 400 signaling the anchor TDLS link, hence still allowing support of the legacy TDLS session setup. This IE 450a replaces (or supplements) the conventional Multi-Link IE 450 required by the D2.0 standard.

Element ID and optionally Element ID Extension fields identify the IE as a Multi-Link IE. As defined above, Multi-Link Control field 460 includes Type field 461 set to TDLS (value: 3).

Common Info field 870 may be conventional Common Info field 470 as described above with reference to FIG. 4b, i.e. containing the Common Info Length field 471 and the AP MLD MAC address field 472.

In particular embodiments, it includes a Link ID Info field 873 comprising a link identifier (Link ID) of an AP that is affiliated with the AP MLD and that corresponds to the first setup communication link (anchor link) signaled in the Link Identifier IE 400. In other words, the Link ID subfield of the Link ID Info field (873) indicates the link identifier used by the non-AP STA that is affiliated with the non-AP MLD and that is described in the TDLS Action fields, namely the Link Identifier IE 400. According to embodiments, it (the anchor TDLS link) is also described in the TDLS ML Element 450a, and link identifier aims to easily identify a corresponding profile 690 (described below). In preferred embodiment, the link identifier corresponds to the BSSID (401) specified in the Link Identifier IE 400. Therefore, the link ID Info field 873 indicates the first or anchor link for the ML TDLS Session.

As an option, Link ID Info subfield 873 is not present in the Common Info field 870 if the TDLS Multi-Link element 450a is sent by a non-AP STA MLD that intends to establish a single Link TDLS session. Its presence may be signaled in bitmap 462 of Multi-Link Control field 460: the Link ID Info Present subfield in the Multi-Link Control field 460 is set to 1 if the Link ID Info subfield 873 is present in the Common Info field 870.

In the example of the Figure, Link Info field 880 provides information of Per-TDLS STA Profile elements 890, i.e. includes one or more Per-TDLS STA Profiles, each of which signaling one TDLS link. In embodiments, the Link Info field 880 carries information specific to the (mandatory or proposed TDLS) links and is mandatory present when TDLS session is multi-link. When the Link Info field is present, it contains one or more subelements 890 corresponding to the one or more Per-TDLS STA Profiles.

The number of elements inside Link Info field 880 corresponds to the number of signaled TDLS links (two for the sake of illustration, but not limitative) when it includes an element (profile) for the anchor link. In other words, one of the Per-TDLS STA Profiles 890a, 890b signals the first/anchor setup communication link. In variants where the anchor link is not described in the Link Info field 880, the number of elements is that number of signaled TDLS links minus 1. Link Info field 880 excludes an element for the anchor link.

The Per-TDLS STA Profiles have the same format.

Subelement ID field 891 can take value “0” as defined for Per-STA Profile used for so-called Basic Multi-Link element as defined in the D2.0 standard. In that case, the following fields, namely STA Control field 892, STA Info field 893 and STA Profile 894 follow the conventional formats.

In a variant, Subelement ID field 891 takes value 1 (or any unused value in the D2.0 standard) to explicitly specify the TDLS context. In that case, STA Control field 892, STA Info field 893 and STA Profile 894 may be optimized to include less subfields, e.g. to include only required subfields dedicated to ML TDLS as described hereinafter.

An exemplary STA Control field 892 is shown in the Figure, based on the format of the STA Control field used for the Basic Multi-Link element. The subfields specific to ML TDLS include all or part of Link ID subfield 8921, STA MAC Address Present subfield 8923 and Ping Required subfield 8929.

Link ID field 8921 is set to a link identifier of an AP that is affiliated with the AP MLD, hence uniquely identifying the TDLS link associated with a per-TDLS STA profile sub-element. The value carried in the Link ID subfield of the Per-TDLS STA Profile subelement carried in a TDLS Multi-Link element is unique to every AP affiliated with an AP MLD and is a representation of the tuple consisting of Operating Class, Operating Channel, and BSSID of the AP affiliated with the AP MLD.

Advantageously, the Link ID fields provided through the multiple Per-TDLS STA Profile sub-elements 890a, 890b may be used in the TDLS discovery and setup frames to indicate one or more requested TDLS links for a direct link.

The STA Control field 892 also includes subfields of a conventional Per-STA Profile, namely:
Complete Profile subfield 8922 set to 0, as the Per-TDLS STA Profile subelement 890a, 890b of the TDLS Multi-Link IE 450a does not intend to carry the complete profile of the links (already done by the AP MLD in its management frames such as beacon or association frames);
STA MAC Address Present subfield 8923 indicating the presence of the STA MAC Address subfield 8932 in the STA Info field 893 and set to 1 as the STA MAC Address subfield shall present in the STA Info field in some embodiments seeking to indicate the MAC address of affiliated non-AP STA on the corresponding link. Indeed, this information is not available for a recipient non-AP MLD, as only the MLD MAC Address is known from field 402;
Beacon Interval Present subfield 8924, TSF Offset Present subfield 8925, DTIM Info Present subfield 8926, BSS Parameters Change Count Present subfield 8928 are Reserved (set to value 0).

In embodiments regarding the NSTR (Non-Simultaneous Transmit-Receive) subfields 8927, the NSTR Link Pair Present subfield in the Per-TDLS STA Control field is always set to 0. This is because Multi-Link TDLS is restricted to non-AP MLDs that are not limited to operation in simultaneous Links subfield (MLD Capabilities and Operations field) such as single radio non-AP MLDs. Furthermore, regarding multi-radio non-AP MLDs, it is expected that the TDLS station limits the number of TDLS intended links in its TDLS Request or Response frames, to the Maximum Number Of Simultaneous Links it supports. As a consequence, the NSTR Link Pair Present subfield is also not useful for the multi-link TDLS mechanism according to the invention. As a result, the NSTR Indication Bitmap subfield can be not present and the NSTR Bitmap Size subfield can be Reserved (value 0).

In some embodiments, a new subfield 8929, “Ping Required”, is added to STA Control field 892 to trigger, at the receiving non-AP STA, two or more responses to the signaling TDLS

Action frame over respectively the signaled second one or more setup communication links, i.e. the TDLS links additional to the anchor link. Indeed, the anchor link can be considered as being available as soon as a response is received (because it means the request has been correctly received through the anchor link). Of course, the Ping Required field may trigger a response over all the TDLS links signaled in the sent frame. This is particularly the case when the anchor link is not the link over which the frame is sent.

Alternatively, new subfield 8929, “Ping Required”, is added (not represented in the figure) to Common Info field 870 to trigger, at the receiving non-AP STA, responses to the signaling TDLS Action frame over all the second one or more setup communication links as signaled by Link Info field 880, i.e. all the TDLS links additional to the anchor link. This presence of such new subfield inside 870 is therefore conditioned to a specific advertisement bit inside Presence bitmap subfield 462.

As a response to a signaling TDLS Action frame setting the Ping Required field, the receiving non-AP MLD (e.g. 130) sends a response TDLS Action frame over each of the signaled second one or more setup communication links on which the receiving non-AP MLD operates. Indeed, the latter may not send such a response over the links it does not operate. The responses allows the other non-AP MLD (having sent the signaling TDLS Action frame) to know on which links the receiving non-AP MLD operates, hence which operational links can be used as TDLS links.

The multiple responses may be duplicates of the same response, meaning they provide the same set of TDLS links within the TDLS Multi-Link element 450a. As an example, a TDLS Setup Response frame 214, responding to a TDLS Setup Request frame that embeds a TDLS Multi-Link element 450a, can be duplicated on each of the signaled TDLS links (including or not the anchor link) to setup the multi-link TDLS session. This is to confirm the corresponding affiliated non-AP STAs on the secondary TDLS links (e.g. 122 and 132) are reachable together. If not, the corresponding link can be removed from the TDLS Multi-Link IE 450a conveyed in the TDLS Setup Confirm frame 215.

Turning now to STA Info field 893, it includes:
STA Info Length subfield 8931 indicating the number of octets in the STA Info field 893.
STA MAC Address subfield 8932 of the STA Info field carrying the MAC address of the STA that operates on the link identified by the Link ID subfield 8921 and is affiliated with the same MLD as the STA that transmitted the TDLS Multi-Link element 450a. As a consequence, each of the Per-TDLS STA Profiles includes a STA MAC Address field set to a MAC address of a STA that is affiliated with the non-AP MLD sending the signaling TDLS Action frame. This allows the MAC addresses of the relevant affiliated STAs (involved in the multi-link TDLS session) to be shared with the other non-AP MLD.
Beacon Interval subfield, TSF Offset subfield, DTIM Info subfield, NSTR Link Pair Present subfield, BSS Parameters Change Count subfield are not set (if present) or not present since the related indication subfields in STA Control 892 are unset (Reserved, with value 0).

Although illustrated with regards to STA Control and STA Info of the Basic Multi-Link element, the STA Control 892 format and STA Info 893 format may be different, taking into account that at least Link ID subfield 8921 and STA MAC Address 8932 (or equivalent) are present.

STA Profile field 894 contains different IEs from those defined for STA Profiles of a Basic Multi-Link IE. This is because STA Profile field 894 aims to provide IEs specific to the TDLS session and not IEs advertised for a reported AP affiliated with an AP MLD (e.g. in the Beacon frame or a Multi-Link Probe Response frame) as in a Basic Multi-Link element. To be noted that the IEs for a reported AP are already advertised to associated STA (e.g. TDLS peer non-AP MLDs 120 and 130) in complete or partial per-link information by the AP.

Therefore, STA Profile field 894 may include all the elements and fields (subject to inheritance discussed below) that would be included as IEs in the set of IEs 303 in the corresponding TDLS Action frame. Table 399 above provides exemplary IEs of a TDLS Setup Action frame. In other words, STA Profile field 894 provides the IEs as defined in IEEE P802.11be/D2.0 for a TDLS Action frame of the same type (e.g. Discovery/Setup Request/Response) as the signaling TDLS Action frame considered.

Although the first, second and third embodiments to signal the TDLS links are described above in an independent manner, they can be combined however. As an example, the Multi-Link Link IE 490a (with bitmap 491) of FIG. 8b can be inserted in the ordered set of IEs 303 of FIG. 8c, before the TDLS Multi-Link IE 450a, to disclose the list of TDLS Link(s) to a recipient TDLS non-AP MLD prior to parse the more complex TDLS Multi-Link IE 450a. This allows the recipient to only parse Per-TDLS STA Profile information 890a, 890b relative to the link(s) it is already operating on with its AP MLD. Preferably, the Per-TDLS STA Profile elements (890a, 890b) are listed in an order relative to the link(s) identifier numbering in order to ease their parsing. In other words, the signaling TDLS Action frame includes a Multi-Link Link IE 490a preceding the TDLS Multi-Link IE 450a within the signaling TDLS Action frame, wherein the Multi-Link Link IE 490a comprises a Link ID Bitmap 490, the bits of which being set to indicate the second one or more of the multiple setup communication links. Again, bit bᵢ in the bitmap corresponds to Link ID “i” (i.e. affiliated APᵢ) within the AP MLD 110.

FIG. 8d illustrates fourth signaling embodiments in TDLS Action frames, which enhance the third embodiments above by providing inheritance between the STA Profile fields 894, in order to save signaling bits. In particular, it is sought that a Per-TDLS STA Profile inherits from the IEs describing the first setup communication link (anchor link) outside the TDLS Multi-Link IE in the signaling TDLS Action frame and includes only IEs that differ from the IEs describing the first setup communication link.

It is possible for STAs affiliated with a non-AP MLD to have similar capabilities and operational parameters on different links. It is even stronger for TDLS elements that indicate the behaviour of non-AP STA MLD for a multi-link TDLS session (few elements compared to all capabilities and operational parameters reported by the non-AP MLD to the AP MLD).

Inheritance concept in 802.11 is traditionally considered with respect to a “reporting” station (that one that transmits) and “reported” stations (the other ones). To match this wording, the description below considers the anchor link (signaled in Link Identifier 400) as being the “reporting” link, while the other signaled TDLS links (hence additional to the anchor link) are referred to as “reported” links. There may be one or more reported links depending on the number of TDLS links solicited for the multi-link TDLS session.

As shown in the Figure, IEs A, B, and C (respectively 801-A, 801-B, 801-C) provides capabilities or operational parameters related to (hence describing) the reporting (anchor) link. They define a basis from which the Per-TDLS STA Profiles 890a, 890b can inherit.

Each Per-TDLS STA Profile 890a; 890b describes a reported TDLS link (reported link).

STA Profile 894a, 894b of such reported links may include same-type IEs but with different values compared to the reported link, typically like IEs B or C (respectively 811-B, 811-C) in the example of the Figure. These IEs with different values cannot inherit from the same-type IEs (801-B, 801-C) of the reporting link, hence they are embedded inside the STA Profile field of the reported TDLS link(s). An IE with the same type is an IE having the same Element ID and Extended Element ID. In the example, Element B IE differs for a first reported link corresponding to Profile 890a, hence STA Profile 894a includes an Element B IE 811-B with its specific value. Element C IE differs for a second reported link corresponding to Profile 890b, hence STA Profile 894b includes an Element C IE 811-C with its specific value.

When the reported link has the same IE (in type and value) as the reporting link, the IE does not need to be repeated in the STA Profile field and can inherit from the reporting link. In the example shown, the first reported link has the same Element A IE and Element C IE as the reporting link, hence they are not included in STA Profile 894a. Similarly, the second reported link has the same Element A IE and Element B IE as the reporting link, hence they are not included in STA Profile 894b.

As a result, an element that is applicable to a reported TDLS Link (inside Per-TDLS STA Profile 890) might have the same value as the corresponding element applicable to the reporting Link and carried in the TDLS setup/discovery frames outside the TDLS Multi-Link element. To reduce the frame size, when a Per-TDLS STA Profile subelement carries profile for a reported Link, it inherits the elements from the reporting Link based on the rules defined herebelow.

Each Per-TDLS STA Profile subelement of the TDLS Multi-Link element that is included in a TDLS setup/discovery frame transmitted by a TDLS STA affiliated with a non-AP MLD shall consist of:
STA Control field 892 to identify the link 8921 (reported TDLS Link) on which the reported STA operates on;
STA Info field 893 to identify the MAC address of the reported affiliated STA (8932) of the reporting TDLS Link;
STA Profile field 894 corresponding to the reported TDLS Link, that:
   carries fields and elements in the same order and subject to conditions as in Table 399, more precisely with reference to IEEE 802.11-REVme/D1.3 (June 2022):
      Table 9-497 (TDLS Setup Request Action field) if the frame is a TDLS Setup Request action frame.
      Table 9-498 (TDLS Setup Response Action field) if the frame is a TDLS Setup Request action frame.
      Table 9-499 (TDLS Setup Confirm Action field) if the frame is a TDLS Setup Confirm action frame.
      Table 9-500 (TDLS Teardown Action field) if the frame is a TDLS Teardown action frame.
   is subject to inheritance rules and exceptions specified hereafter;
   does not include the following elements (from Table 399) that apply at the MLD level and have the same value for all links: Capability, RSNE, Extended Capabilities, QoS Capability, FTE, Timeout Interval (TPK key lifetime), Supported Operating Classes, HT Capabilities, 20/40 BSS Coexistence, AID, VHT Capabilities, S1G Capabilities, HE Capabilities, HE 6 GHz Band Capabilities, and the same elements from operation perspective rather than capability perspective (hence the elements named with “Operation” instead of “Capability/ies”).
   does not include a so-called Non-Inheritance element as defined in section 9.4.2.240 of the D2.0 standard (see D2.0, section 35.3.2.4.1 (Inheritance in the per-STA profile of Basic Multi-Link element)).

As inheritance rules, it is proposed that a STA that transmits a TDLS Action frame carrying the TDLS Multi-Link element 450a shall include an element that is specific to the reported Link in the profile of the reported STA carried in the TDLS Multi-Link element. An element, identified by an Element ID and Element ID Extension (if applicable), is considered specific to a reported Link if at least one element with the same Element ID and Extended Element ID (if applicable) is present in the TDLS Action frame that carried the TDLS Multi-Link element, but the contents of the Information field is not the same for the reported link (if the reported STA were to transmit the same TDLS Action frame).

As an exception, some 802.11 mechanisms (also referred to as “link-specific procedures”) are defined on a given radio medium, hence operate on a given link, independently of the other links.

For instance, this is the case of the Target Wake Time (TWT) procedure or of its recent adaptation known as Restricted Target Wake Time (rTWT) procedure. For example, the TWT procedure can be defined for a first link, that is to say anchor link used to setup the multi-link TDLS session, as listed in Table 399, or for another link than the anchor link. As it is a link-specific procedure, the TWT element shall not be inherited in a reported link.

As another example, the identification of each link is a link-specific mechanism. In this respect, a Link Identifier IE in a STA Profile 894 of a Per-TDLS STA Profile 890 of a reported link cannot inherit from the Link Identifier IE 400 of the reporting link. In other words, the conventional Link Identifier IE 400 signaling the anchor TDLS link is not inherited in a reported link. According to embodiments, this is also the case for Multi-Link Link IE 490a (with bitmap 491).

As exemplarily shown in the Figure, Element D (811-D) is an IE related to a link-specific procedure (e.g. TWT element or Link Identifier ID) present for the second reported link only. It is therefore present in STA Profile 894b, while being absent amongst the IEs of the reporting Link as well as amongst the IEs of the other reported links (e.g. STA Profile 894a).

In other words, if an element, identified by an Element ID and Element ID Extension (if applicable), is carried in a TDLS Action frame transmitted by the TDLS STA in reporting Link, and there is no element having the same Element ID and Element ID Extension (if applicable) in a reported Link (801), then the element is considered to be part of the reported Link's profile (Per-TDLS STA profile).

Specific to the scenario where the TDLS Multi-Link IE 450a includes a Per-TDLS STA Profile 890 for the reporting (anchor) link, the STA Profile 894 of that Per-TDLS STA Profile 890 is empty as all the IEs are already provided in the set of IEs 303 and are therefore inherit.

According to some embodiments, Per-TDLS STA Profile element fragmentation is forbidden. The length of a Per-STA Profile element for a reported STA may therefore not exceed 255 octets.

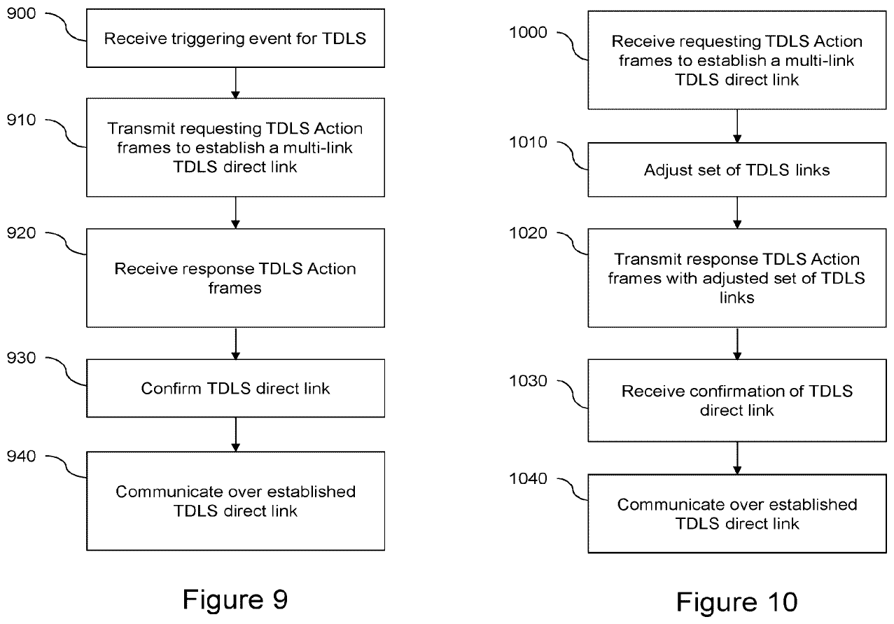

FIG. 9 illustrates exemplary steps of wireless communications involving TDLS at a TDLS initiator non-AP MLD, in accordance with embodiments of the present invention, while FIG. 10 illustrates exemplary steps of wireless communications involving TDLS at a TDLS responder non-AP station or MLD, in accordance with embodiments of the present invention.

The operations at the initiator begin at step 900 where a triggering event is detected that triggers the method of initiating a TDLS session with multiple links, hence a multi-link TDLS direct link. A multi-link TDLS session is understood as a TDLS session established using any of the above embodiments to signal one or more TDLS links. This may however lead to establishing a TDLS with a single link despite the signaling of multiple links, when, e.g., only one link is common to the TDLS initiator non-AP MLD and the peer partner (non-AP MLD or station).

Different types of triggering events may be contemplated.

As examples, the TDLS initiator non-AP MLD may detect some P2P traffic in its transmission buffer, or may detect that an amount of such P2P traffic exceeds a triggering threshold, or may detect a change in network conditions that requires traffic intended to a non-AP station or MLD to be directly sent instead of transiting through the AP MLD, or may receive an instruction from the AP MLD to implement direct links where possible.

This triggering step 900 allows the TDLS initiator non-AP MLD to know its peer partner, e.g. thanks to the destination address of the P2P traffic to be sent.

At this stage, the TDLS initiator non-AP MLD does not know whether the peer partner is a non-AP MLD implementing the invention, or a mere legacy 802.11 station or a single-radio station that cannot implement multi-link TDLS direct links. The TDLS initiator non-AP MLD only knows a MAC address (be it MLD MAC address or STA MAC address).

At step 910, the TDLS initiator non-AP MLD starts, using one of its affiliated STAs, exchanging TDLS Action frames with the peer partner, using the TDLS mechanism (FIG. 2) augmented with the signaling according to any embodiments of the invention.

The affiliated STA of the TDLS initiator non-AP MLD thus sends a first TDLS Request frame to the peer partner (either an affiliated STA of a responder non-AP MLD or the responder non-AP station itself). The latter receives the frame at step 1000.

Steps 910 and 1000 may include the exchange of several TDLS Request frames to establish a TDLS direct link between the two entities, e.g. an optional TDLS Discovery Request frame followed by a TDLS Setup Request frame. Steps 920 and 1020 described below include the exchange of corresponding TDLS Response frames, e.g. an optional TDLS Discovery Response frame followed by a TDLS Setup Response frame.

As mentioned above, one or more of the exchanged frames include IEs to signal two or more TDLS links, on which to establish a multi-link TDLS direct link. Any of the first, second, third or fourth embodiments described above may be used for such signaling.

This signaling includes the conventional Link Identifier IE 400 enabling any legacy station to properly establish a conventional single-link TDLS session based on the (anchor) link specified in this IE.

First exchanged frames may include a TDLS Discovery Request frame 211 (from the initiator) and a TDLS Discovery Response frame 212 (from the responder) in response. The TDLS Discovery Request frame has a transmitter address (TA) field set to the STA MAC address of the transmitting affiliated STA of the TDLS initiator non-AP MLD (e.g. STA 121 for initiator MLD 120), and has a Destination address (DA) set to the known address of the peer partner (either the MLD MAC address of 130 or a STA address of a legacy non-MLD station).

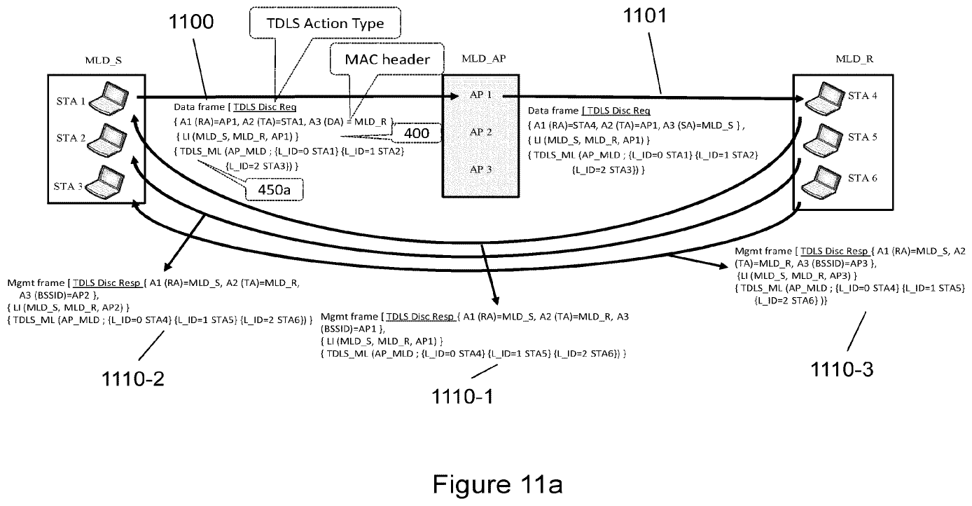

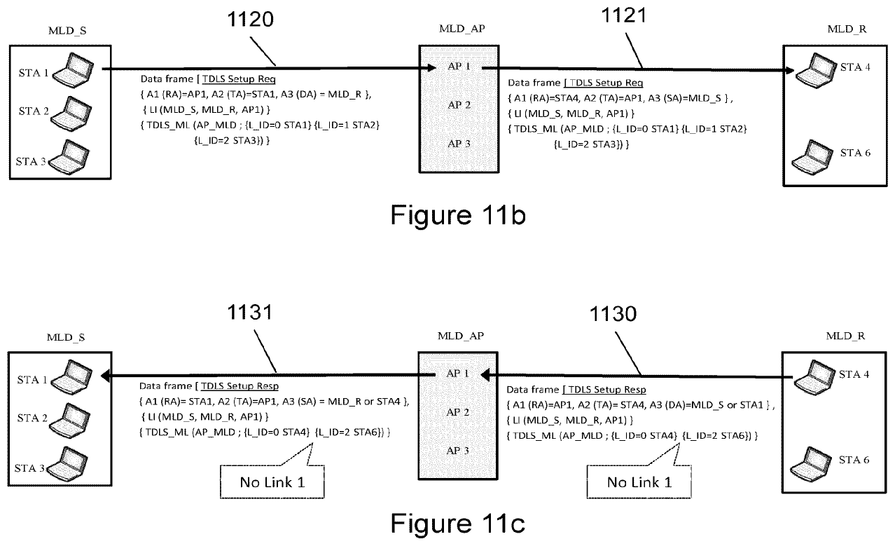

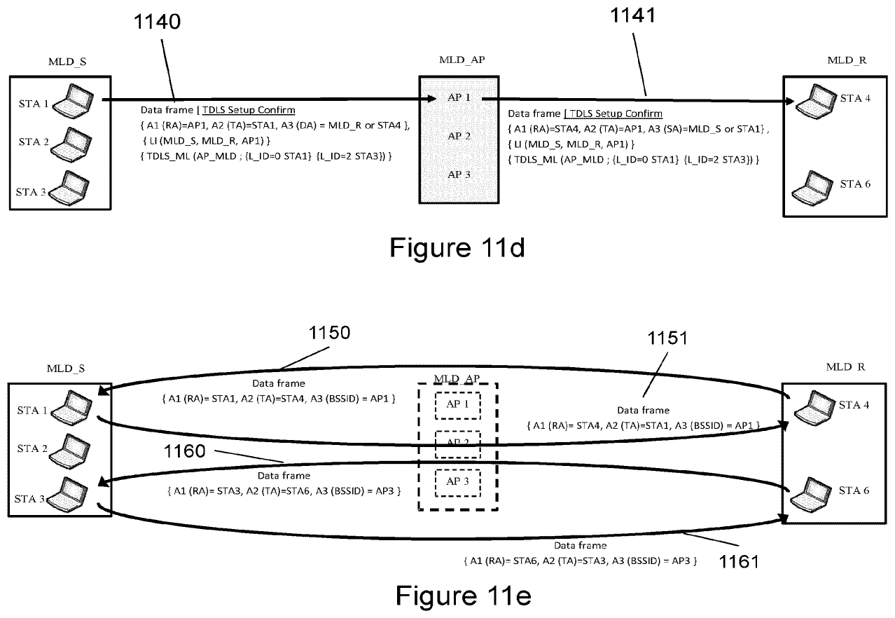

FIG. 11a illustrates, using a frames sequence, such a Multi-Link TDLS Discovery procedure according to embodiments of the invention.

It illustrates a non-AP MLD (MLD_S) initiating a Multi-Link TDLS discovery with another non-AP MLD (MLD_R).

The TDLS initiator non-AP MLD selects an anchor or recommended link, so that the BSSID field 401 of the Link Identifier element 400 is set to the AP affiliated with the AP MLD corresponding to that link (“AP1” in the example corresponding to BSSID1).

As shown, affiliated STA1 of MLD_S transmits, to AP1 of MLD_AP, a TDLS Discovery Request frame 1100 with the TA field set to the STA1's STA MAC address and the DA field set to the known peer partner's MAC address (here MLD MAC Address “MLD_R”). The frame includes Link Identifier element 400 defining link with AP1 as anchor link (through triplet: MLD_S, MLD_R, AP1), and includes TDLS Multi-Link IE 450a signalling three intended TDLS links using its corresponding STA MAC addresses, including the anchor link (this is however an option). For example, {L_ID=2 STA3} signals secondary link 2 with the STA MAC address of STA 3.

Due to the nature of multi-link operation, when a Data frame traverses the AP MLD, it can be relayed on any available link. Furthermore, when a frame that was transmitted by a STA of a non-AP MLD (e.g. MLD_S) traverses the AP MLD, the AP MLD sets the SA field to the transmitting STA's MLD MAC address (e.g. MLD_S).

AP1 thus relays, to STA4, the TDLS Discovery Request frame 1101 with the SA field set to the MLD_S's MLD MAC address.

Thanks to the TDLS Multi-Link IE 450a, STA4 is now aware of the affiliated STAs of MLD_S (STA1, STA2, and STA3). MLD_R is therefore able, using also BSSID 401 in Link Identifier 400 and/or Link ID info field 873, to determine which of its affiliated STAs correspond to the affiliated STAs of MLD_S, i.e. share the same link (or is associated with the same affiliated AP) as the affiliated STAs of MLD_S.

If it is determined that STA4 shares a link with a STA (STA1) affiliated with MLD_S and corresponding to the anchor link (AP1 signalled in Link Identifier 400 and/or subfield 873 of TDLS Multi-Link IE 450a), STA4 transmits directly, to STA1 of MLD_S, a TDLS Discovery Response frame (1110-1).

Furthermore, according to the value of the Ping Required bit-field 8929, one or more secondary link(s) listed in the Per-TDLS STA Profiles 890 are used by MLD_R to transmit a TDLS Discovery Response frame 1110-2 and 1110-3. As shown, STA5 of MLD_R transmits response frame 1110-2 and STA6 of MLD_R transmits response frame 1110-3 in their respective link, as they share common links with affiliated STAs of MLD_S.

Step 1020 illustrates the transmission of such response frames at the responder side, while step 920 illustrates the corresponding reception at the initiator side.

The RA field of those response frames may be set to the MLD MAC address of MLD_S; and the TA field of those frames may be set to the MLD MAC address of MLD_R. As the frames are directly transmitted, the last address A3, i.e. BSSID, is set to the AP corresponding to the transmitting STA, hence AP1 for frame 1110-1, AP2 for frame 1110-2 and AP3 for frame 1110-3.

Thanks to the invention enabling MLD_R to obtain the STA MAC addresses of the affiliated STAs of MLD_S (thanks to TDLS Multi-Link IE 450a), in some embodiments, RA field and TA field may be set (not shown in the Figure) with the STA MAC addresses of the respective receiving and transmitting affiliated STAs. More generally, responsive to the received TDLS Discovery Request frame, the TDLS responder non-AP MLD sends a TDLS Discovery Response frame with a receiving address, RA, set to the MAC address of the STA. This advantageously avoids continuing with the RA setting rule exception as defined in section 35.3.3 of the D2.0 standard, requiring such field to carry a MLD MAC address for single link TDLS direct links.

That is, the TDLS Discovery Response frame 1101-i has a MAC header set to the STA MAC addresses of the transmitting/receiving STAs affiliated with the MLDs corresponding to that link. As an example (not shown in the figure), 1110-1 may consider having its MAC header no longer as:

$$A 1 ( RA ) = MLD\_S , A 2 ( TA ) = MLD\_R , A 3 ( BSSID ) = AP 1$$

but:

$$A 1 ( RA ) = STA 1 , A 2 ( TA ) = STA 4 , A 3 ( BSSID ) = AP 1.$$

One may also note that although the signaling of STA MAC addresses instead of MLD MAC addresses in the MAC header is introduced with reference to a multi-link TDLS direct link, it may similarly applies with a single-link TDLS direct link (as introduced in the D2.0 standard) provided that the TDLS Multi-Link IE 450a be used according to embodiments of the present invention to signal the single (anchor) link intended for the TDLS direct link. Indeed, this IE 450a therefore provides the responder with the STA MAC address (field 8932) of the active TDLS affiliated STA of MLD_S. TDLS Multi-Link Info 450a is included in TDLS frames but contains a single entry 890 having specifying the Link ID subfield 8921 and STA MAC Address subfield 8932.

The Link Identifier IE 400 in the response frames 1110-i may be kept as it is in the TDLS Discovery Request frame 1101, specifying the two MLD MAC addresses, and the anchor link through “AP1”.

However, in some embodiments as illustrated in the scenario of the Figure, the content of Link Identifier IE 400 may be specialized per link. The responder non-AP MLD MLD_R may set the BSSID field 401 contained in the Link Identifier element 400 of the response frames to the BSSID of the corresponding AP affiliated with the AP MLD that is operating on the link on which the response frame (1110-i) is transmitted in direct path. That is, BSSID field 401 is set to AP1 for response frame 1110-1, to AP2 for response frame 1110-2, and to AP4 for response frame 1110-3.

As already discussed, the STA MAC Address subfield 8932 of the STA Info field 893 carries the STA MAC address of the affiliated STA that operates on the link identified by the Link ID subfield 8921. Therefore, the TDLS Discovery Response frames 1110-1, 1110-2 and 1110-3 contain different MAC address values in the Per-TDLS STA Profiles 890 compared to the TDLS Discovery Request frame 1101. In the example of the Figure, the three Per-TDLS STA Profiles include respectively STA MAC addresses of STA4, STA5, STA6 for each link 0, 1, 2 respectively.

It is to be noted that depending on the links enabled at MLD_R, the response frames 1110-i may signal a subset of the links signaled in the request frame 1101. This is a sort of negotiation (step 1010) through which the responder non-AP MLD informs the initiator non-AP MLD of its constraints regarding available links for a multi-link TDLS session.

After the peer partner (MLD_R) has been successfully discovered, the initiator non-AP MLD sets the BSSID field 401 contained in the Link Identifier element 400 of the subsequent TDLS Action frames to the BSSID of the corresponding AP affiliated with the AP MLD that is operating on the link on which a response frame 1110-i has been received, preferably the anchor link if a response frame has been received over it. The initiator non-AP MLD sets the TDLS Multi-Link Info 450a of the subsequent TDLS Action frames according to all of or a subset of the discovered links with MLD_R.

Subsequent TDLS Action frames include TDLS Setup frames.

FIGS. 11b and 11c illustrate, using a frames sequence, a Multi-Link TDLS Setup Request frame and associated Multi-Link TDLS Setup Response frame according to embodiments of the invention. The transmission and reception of the request frame correspond to steps 910 and 1000, while the transmission and reception of the response frame correspond to steps 920 and 1020.

In this example, MLD_R has only two affiliated STAs (operating on links 0 and 2). Hence, it can at best establish a multi-link TDLS session on two TDLS links, although the initiator non-AP MLD may propose more candidate TDLS links.

FIG. 11b illustrates the transmission of a TDLS Setup Request frame (1120-1121) to non-AP MLD MLD_S, wherein three TDLS links are proposed as candidate links for the multi-link TDLS session: link 0, 1, 2 (corresponding to STA1, STA2, STA3 as signaled in TDLS Multi-Link IE 450a, possibly repeating the anchor link of Link Identifier IE 400). Thanks to the invention, a single frame exchange on one link is needed to setup/establish a multi-link TDLS direct link between the two non-AP MLDs.

As shown in the Figure, the TDLS Setup Request frame 1120, 1121 is transmitted by the non-AP MLD, MLD_S, through affiliated STA1, is tunneled through the AP MLD and is received by MLD_R through affiliated STA4. The BSSID field 401 in the Link Identifier IE 400 identifies the anchor (recommended) link for establishing the multi-link TDLS direct link. The TDLS Multi-Link IE 450a identifies (at least) the proposed secondary link(s) for establishing the multi-link TDLS direct link.

The TDLS Setup Request frame 1120, 1121 may be transmitted over the anchor link or over any other link.

At step 1010, the responder MLD may decide to setup the multi-link TDLS session on a subset of the TDLS links as proposed in the request 1121. Typically, the responder MLD is not allowed to setup TDLS links for which it is not operating on with the AP MLD, like Link 1 in the Figure. Therefore, at step 1010, the responder MLD adjusts the set of TDLS links.

Next, the responder MLD sends at step 1020 the response frame embedding the adjusted set of TDLS links, which frame is received by the initiator MLD at step 920.

FIG. 11c illustrates the transmission of a TDLS Setup Response frame (1130-1131) between two STAs each affiliated with a different non-AP MLD (MLD_R). Again, a single frame exchange on one link is needed to set up the multi-link TDLS direct link.

As for the Discovery procedure, the response may use STA MAC addresses in the MAC header instead of MLD MAC addresses (in particular for the destination address DA), as MLD_R now knows the STA MAC address of the affiliated STA (STA1) of MLD_S operating on the same link as its transmitting affiliated STA (STA4). More generally, responsive to the received TDLS Setup Request frame, the TDLS responder non-AP MLD sends a TDLS Setup Response frame with a destination address, DA, set to the MAC address of an affiliated STA of the initiator non-AP MLD.

The anchor link in the Link Identifier IE 400 can be kept unchanged compared to the TDLS Setup Request frame 1121, in particular if it is kept in the adjusted set of TDLS links (obtained at step 1010). In a variant (not shown), MLD_R may decide to change the anchor link by signalling another BSSID in Link Identifier IE 400.

The secondary link(s) signaled in the TDLS Multi-Link IE 450a may be those of the setup request frame 1121, but with STA MAC addresses 8932 set to the corresponding affiliated STAs of MLD_R. In variants where step 1010 is implemented, only the secondary links of the adjusted set of TDLS links are signaled in the TDLS Multi-Link IE 450a.

The TDLS Setup Response frame (1130-1131) is sent preferably over the same link (here AP1) as the TDLS Setup Request frame 1121. However, the TDLS responder may prefer using another link, be it the anchor link or not.

In some embodiments (not shown in the figure), the new subfield 8929, “Ping Required”, is present in the TDLS Multi-Link IE 450a of the TDLS Setup Request frame (1120-1121) to trigger, at the receiving non-AP STA, a TDLS Setup Response frame over the secondary link(s).

In the example of the Figure, as MLD_R does not operate on Link 1, the response frame only signals the anchor link in Link Identifier IE 400 (e.g. Link 0) and a single secondary link in TDLS Multi-Link IE 450a (e.g. Link 2). Optionally the anchor link may be repeated (with the STA MAC address of the corresponding affiliated STA) in TDLS Multi-Link IE 450a. This is the case in the Figure.

Thanks to the TDLS Action frame exchanges operated at steps 910/920 and 1000/1010/1020, the initiator non-AP MLD and responder non-AP MLD agree on a set of TDLS links to establish the multi-link TDLS direct link.

This set is confirmed by the initiator non-AP MLD through the transmission of a TDLS Setup Confirm frame as illustrated in FIG. 11d. This frame is sent by the initiator non-AP MLD at step 930 while it is received by the responder non-AP MLD at step 1030.

The TDLS Setup Confirm frame 1140 specifies the proposed service parameters for the TDLS setup, that is to say the negotiated TDLS link(s) that support multi-link TDLS direct link according to embodiments.

The TDLS Setup Confirm frame 1140 is transmitted through the AP (and then relayed), in the same manner as the TDLS Setup Request frames 1120-1121.

If a TDLS Setup Confirm frame 1140 is transmitted with a status code other than SUCCESS, the TDLS initiator non-AP MLD may resume transmitting MSDUs to the TDLS responder non-AP MLD through the AP. Conversely, if such a TDLS Setup Confirm frame is received with a status code other than SUCCESS, the TDLS responder non-AP MLD may resume transmitting MSDUs to the TDLS initiator non-AP MLD through the AP.

As shown in the Figure, the TDLS Setup Confirm frame 1140, 1141 may still include a Link Identifier 400 IE signalling a first TDLS link (anchor link) and a TDLS Multi-Link IE 450a signalling one or more secondary TDLS links. This aims at confirming the set of TDLS links to be used, to the responder MLD.

Frame 1140, 1141 ends the setup of the multi-link TDLS direct link. When it is successfully established, it is between at least one TDLS STA affiliated with the initiator non-AP MLD and at least one TDLS peer STA affiliated with the responder non-AP MLD, at the other end of the direct link.

FIG. 11e illustrates, using a frames sequence, an exemplary frame exchange over a multi-link TDLS direct link where at least one of the peer STAs is a TDLS STA affiliated with a non-AP MLD.

Thanks to the invention providing the STA MAC addresses of the affiliated STAs in the exchanged TDLS Action frames, it is now possible for the TDLS peer STA (at both the initiator and responder sides) to directly include the STA MAC addresses in the MAC header of the exchanged data frames, and no longer to rely on the MLD MAC addresses only. In other words, when performing a direct link exchange, a peer non-AP MLD sends a data frame directly to the other non-AP MLD over one of the TDLS links, the data frame having a MAC header in which a receiving address, RA, field is set to a MAC address of an affiliated station of the other non-AP MLD that corresponds to the TDLS link used. This simplifies the reception of the data frames by the other peer.

In the Figure, STA1 and STA4 directly transmit data frames with the RA/TA fields set with their STA MAC addresses over Link 0, while STA3 and STA6 directly transmit data frames with the RA/TA fields set with their STA MAC addresses over Link 2.

The data frame exchanges over the multi-link TDLS direct link correspond to step 940 (at initiator side) and step 1040 (at responder side).

As mentioned earlier, the set of TDLS links on which the multi-link TDLS direct link is established may evolve over time. In the example above (step 530), a TDLS Teardown frame is used to that end (e.g. to signal a new link or a link to tear down).

In a variant, a TDLS Setup Request frame as described above can be used to open new additional links or tear down existing TDLS links for an existing multi-link TDLS session. The TDLS links signaled in that frame (in Link Identifier IE 400 and/or TDLS Multi-Link IE 450a) that are not yet in the current set of TDLS links can be considered as new TDLS links to be opened for the existing multi-link TDLS session. Similarly, the TDLS links of the current set that are no longer signaled in the frame can be torn down.

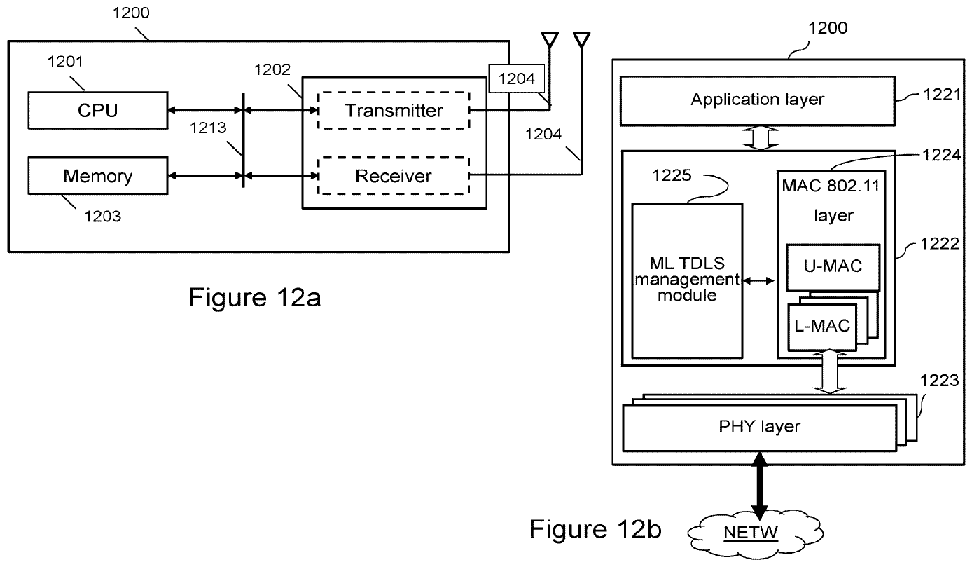

FIG. 12a schematically illustrates a communication device 1200, in particular a non-AP MLD embedding a plurality of affiliated non-AP stations, of a radio network NETW, configured to implement at least one embodiment of the present invention. The communication device 1200 may preferably be a device such as a micro-computer, a workstation or a light portable device. The communication device 1200 comprises a communication bus 1213 to which there are preferably connected:
a central processing unit 1201, such as a processor, denoted CPU;
a memory 1203 for storing an executable code of methods or steps of the methods according to embodiments of the invention as well as the registers adapted to record variables and parameters necessary for implementing the methods; and at least one communication interface 1202 connected to a wireless communication network, for example a communication network according to one of the IEEE 802.11 family of standards, via transmitting and receiving antennas 1204.

Preferably the communication bus provides communication and interoperability between the various elements included in the communication device 1200 or connected to it. The representation of the bus is not limiting and in particular the central processing unit is operable to communicate instructions to any element of the communication device 1200 directly or by means of another element of the communication device 1200.

The executable code may be stored in a memory that may either be read only, a hard disk or on a removable digital medium such as for example a disk. According to an optional variant, the executable code of the programs can be received by means of the communication network, via the interface 1202, in order to be stored in the memory of the communication device 1200 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 12b is a block diagram schematically illustrating the architecture of the communication device 1200, adapted to carry out, at least partially, the invention. As illustrated, device 1200 comprises a physical (PHY) layer block 1223, a MAC layer block 1222, and an application layer block 1221.

The PHY layer block 1223 (here multiple 802.11 standardized PHY layer modules) has the task of formatting, modulating on or demodulating from any 20 MHz channel or the composite channel, and thus sending or receiving frames over the radio medium NETW, such as 802.11 frames, for instance data frames such as TDLS Action frames to setup a TDLS session, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1222 preferably comprises a MLE MAC 802.11 layer 1224 implementing conventional 802.11 MAC operations, and additional block 1225 for carrying out, at least partially, embodiments of the invention. The MAC layer block 1222 may optionally be implemented in software, which software is loaded into RAM 1203 and executed by CPU 1201. The MLE MAC 802.11 layer 1224 may implement an Upper-MAC stack along with a series of Lower-MAC modules.

Preferably, the additional block 1225, referred to as Multi-Link TDLS management module for performing TDLS service over multi-link communications, implements part of embodiments of the invention (at a peer non-AP MLD). This block performs the operations of FIGS. 5 to 11 depending on the role of the communication device 1200, initiator or partner peer.

MAC 802.11-layer 1224 and Multi-Link TDLS management 1225 interact one with the other in order to establish and process accurately communications in between multiple non-AP MLD stations according to embodiments of the invention.

On top of the FIG. 12b, application layer block 1221 runs an application that generates and receives data packets, for example P2P data packets such as a video stream. Application layer block 1221 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising at a non-access point, AP, multi-link device, MLD, having multiple setup communication links with an AP MLD:
establishing a Tunneled Direct Link Setup, TDLS, direct link with another non-AP station or MLD, by exchanging TDLS Action frames,
wherein one of the TDLS Action frames signals two or more of the multiple setup communication links, on which to establish the TDLS direct link.

2. The method of claim 1, wherein the signaling TDLS Action frame includes a Link Identifier information element, IE, to signal a first one of the multiple setup communication links, and one or more additional IEs to signal a second one or more of the multiple setup communication links.

3. (canceled)

4. The method of claim 2, wherein the signaling TDLS Action frame includes a plurality of Link Identifier IEs, each signaling one of the multiple setup communication links.

5. The method of claim 2, wherein the signaling TDLS Action frame includes a Multi-Link Link IE signaling the second one or more of the multiple setup communication links.

6. The method of claim 2, wherein the signaling TDLS Action frame further includes a Multi-Link IE having a Type field set to TDLS, signaling the second one or more of the multiple setup communication links.

7. The method of claim 6, wherein a Link Info field of the TDLS Multi-Link IE includes one or more Per-TDLS STA Profiles, each of which signaling one of the multiple setup communication links.

8. The method of claim 7, wherein each of the Per-TDLS STA Profiles includes a Link ID field set to a link identifier of an AP that is affiliated with the AP MLD.

9. The method of claim 8, wherein each of the Per-TDLS STA Profiles includes a STA MAC Address field set to a MAC address of a STA, that is affiliated with the non-AP MLD sending the signaling TDLS Action frame, and that is associated with the AP identified in the Link ID field.

10. The method of claim 9, further comprising at the non-AP MLD receiving the signaling TDLS Action frame, responsive to the signaling TDLS Action frame, sending a response TDLS Action frame with a receiving address, RA, or destination address, DA, set to the MAC address of the STA.

11. The method of claim 6, wherein the TDLS Multi-Link IE includes a subfield set to a value triggering two or more responses to the signaling TDLS Action frame over respectively the signaled second one or more setup communication links.

12. The method of claim 11, further comprising at the non-AP MLD receiving the signaling TDLS Action frame, responsive to the signaling TDLS Action frame, sending a response TDLS Action frame over each of the signaled second one or more setup communication links on which the receiving non-AP MLD operates.

13. The method of claim 7, wherein one of the Per-TDLS STA Profiles signals the first setup communication link.

14. The method of claim 7, wherein at least one of the Per-TDLS STA Profiles includes a STA Profile providing the IEs as defined in IEEE P802.11be/D2.0 for a TDLS Action frame of the same type as the signaling TDLS Action frame.

15. The method of claim 7, wherein the signaling TDLS Action frame includes IEs describing the first setup communication link outside the TDLS Multi-Link IE, and a Per-TDLS STA Profile in the TDLS Multi-Link IE inherits from the IEs describing the first setup communication link and includes only IEs that differ from the IEs describing the first setup communication link.

16. The method of claim 15, wherein an IE corresponding to a link-specific mechanism is not inherited from the IEs describing the first setup communication link.

17. (canceled)

18. The method of claim 6, wherein the signaling TDLS Action frame includes a Multi-Link Link IE preceding the TDLS Multi-Link IE within the signaling TDLS Action frame, wherein the Multi-Link Link IE comprises a Link ID Bitmap, the bits of which being set to indicate the second one or more of the multiple setup communication links.

19. The method of claim 1, further comprising at the non-AP MLD, once the TDLS direct link is established on a plurality of setup communication links, exchanging a TDLS Teardown or Setup Request frame with the other non-AP station or MLD, wherein the TDLS Teardown or Setup Request frame signals an updated plurality of setup communication links on which updating the TDLS direct link.

20-22. (canceled)

23. A Tunneled Direct Link Setup, TDLS, Action frame used to establish a TDLS direct link between non-AP stations or MLDs, comprising one or more information elements, IEs, signaling two or more multiple setup communication links, on which to establish the TDLS direct link.

24. A wireless communication device comprising at least one microprocessor configured for carrying out the method of claim 1.

25. A non-transitory computer-readable medium storing a program which, when executed by a microprocessor or computer system in a wireless device, causes the wireless device to perform the method of claim 1.
